(19) United States
(12) Patent Application Publication
(10) Pub. No.: US 2014/0089211 A1
(43) Pub. Date: Mar. 27, 2014

(54) COMMUNICATION MANAGEMENT SYSTEMS AND RELATED METHODS

(71) Applicant: EvenUp Inc., Evergreen, CO (US)

(72) Inventor: Douglas Guy Kittelsen, Evergreen, CO (US)

(73) Assignee: EvenUp Inc., Evergreen, CO (US)

(21) Appl. No.: 14/038,362

(22) Filed: Sep. 26, 2013

Related U.S. Application Data
(60) Provisional application No. 61/706,010, filed on Sep. 26, 2012.

(51) Int. Cl. G06Q 40/02; G06Q 50/18

(52) U.S. Cl. CPC G06Q 40/025; G06Q 50/18
USPC 705/311

(57) ABSTRACT

An apparatus can include: a defined contact module configured to run on at least one processor and further configured to allow a borrower to identify approved communications mechanisms, the approved communications mechanisms comprise allowed methods of communication from one or more creditors to the borrower; a legal notification generation module configured to run on the at least one processor and further configured to generate one or more appropriate legal notifications to the one or more creditors based upon the approved communications mechanisms; a legal notification delivery module configured to run on at least one processor and further configured to facilitate the delivery of the one or more appropriate legal notifications to the one or more creditors using a traceable mechanism; and a communications module configured to run on the at least one processor and further configured to facilitate and store synchronous or asynchronous communications between the borrower and the one or more creditors using the approved communications mechanisms.

### CROSS-REFERENCE TO RELATED APPLICATIONS

This application claims the benefit of U.S. Provisional Application No. 61/706,010, filed Sep. 26, 2012. U.S. Provisional Application No. 61/706,010 is incorporated herein by reference.

### TECHNICAL FIELD

The present disclosure relates generally to the field of communications, and relates, more particularly, to communications management systems and related methods.

### DESCRIPTION OF THE BACKGROUND

Several methods currently exist for parties to communicate with each other. For example, parties can communicate with each other electronically, such as via telephone, email, text, and/or voice messaging, or physically, such as via paper letters or postal correspondence. Parties to a legal agreement often specify in such agreements physical addresses where they can be contacted, but not much else. In some cases, a party can wish to use one or more of these mechanisms to contact the other party with respect to the legal agreement.

One of the most common types of legal agreements is the granting of credit between a creditor party (creditor) and a borrower. If a borrower is late in making payments, creditors will likely wish to employ many different mechanisms to contact the borrower. These methods can include calling borrowers (at work, at home, on their cellular phone), calling the neighbors of borrowers, calling the family of borrowers, etc. While many regulations exist that limit the frequency of use of telephone methods and exclude (by direct reference or absence of allowance) the use of non-telephone methods to contact borrowers, creditors are now also utilizing texting and other electronic and social media tools in an effort to contact borrowers with the hopes of resolving outstanding issues. Generally, those regulations make it illegal for the creditor to disclose to any third party that the communication is regarding a collection of debt and therefore the content of the messages can only contain contact information and a request to have the borrower communicate back to the borrower.

In many jurisdictions, a borrower has the right to send a “Cease and Desist” (“CD”) letter to a creditor, where the CD letter essentially states that creditors should no longer attempt to contact the borrower. If a borrower elects to send the CD letter, borrowers will still retain the right to contact creditors, but creditors will not be allowed to initiate contact to the borrower. In such cases, creditors' only remaining option would be to pursue legal action against borrowers. In many jurisdictions, the fines for not properly adhering to a CD letter are significant, such that most creditors will place the account into a “no contact” queue, will not make any attempt to settle outstanding issues with borrowers, and will write-off that debt if the balance is relatively small. Such write-off will negatively impact borrowers' credit report and, therefore, their ability to acquire new loans in the future.

Accordingly, to prevent such breakdown in communication between parties, a need exists for a communications system that allows the parties to regulate and manage communications there between.

### BRIEF DESCRIPTION OF THE DRAWINGS

To facilitate further description of the embodiments, the following drawings are provided in which:

FIG. 1 illustrates a block diagram of a communications management system configured to provide communications between two or more parties to one or more binding legal agreements, according to a first embodiment;

FIG. 2 illustrates a flow chart for an embodiment of a method of managing communications between a borrower and one or more creditors;

FIG. 3 illustrates a flow chart for an exemplary embodiment of an activity of receiving information regarding approved communications mechanisms;

FIG. 4 illustrates a flow chart for an exemplary embodiment of an activity of facilitating communication using the approved communications mechanisms between the creditors and the borrower;

FIG. 5 illustrates a flow chart for an embodiment of a method for using a communications management system;

FIG. 6 illustrates a flow chart for an embodiment of a method of establishing a new account with the communications management system;

FIG. 7 illustrates a flow chart for an embodiment of a method of connecting two or more parties;

FIG. 8 illustrates a flow chart for an embodiment of a method of reviewing an account;

FIG. 9 illustrates a flow chart for an embodiment of a method for creating a new communication connection;

FIGS. 10 and 11 illustrate a flow charts for embodiments of methods for facilitating and evaluating asynchronous messages;

FIGS. 12-17 illustrate various exemplary graphical user interfaces used with the communications management system of FIG. 1 and the methods of FIGS. 2-11;

FIG. 18 illustrates a computer that is suitable for implementing an embodiment of computer system of FIG. 1; and

FIG. 19 illustrates a representative activity diagram of an example of the elements included in the circuit boards inside chassis of the computer of FIG. 17.

For simplicity and clarity of illustration, the drawing figures illustrate the general manner of construction, and descriptions and details of well-known features and techniques can be omitted to avoid unnecessarily obscuring the invention. Additionally, elements in the drawing figures are not necessarily drawn to scale. For example, the dimensions of some of the elements in the figures can be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but can include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements can be electrically coupled but not be mechanically or otherwise coupled; two or more mechanical elements can be mechanically coupled, but not be electrically or otherwise coupled; two or more electrical elements can be mechanically coupled, but not be electrically or otherwise coupled. Coupling can be for any length of time, e.g., permanent or semi-permanent or only for an instant.

### DETAILED DESCRIPTION OF EXAMPLES OF EMBODIMENTS

Some embodiments concern an apparatus configured to provide communications and event tracking between a borrower and one or more creditors to the borrower. The apparatus can include: a defined contact module configured to run on at least one processor and further configured to allow the borrower to identify approved communications mechanisms, the approved communications mechanisms comprise allowed methods of communication from the one or more creditors to the borrower; a legal notification generation module configured to run on at least one processor and further configured to generate one or more appropriate legal notifications to the one or more creditors based upon the approved communications mechanisms; a legal notification delivery module configured to run on at least one processor and further configured to facilitate the delivery of the one or more appropriate legal notifications to the one or more creditors using a traceable mechanism; and a communications module configured to run on at least one processor and further configured to facilitate communication between the borrower and one or more creditors using the approved communications mechanisms, the communications module can have a synchronous communications module configured to provide real-time communications between the borrower and one or more creditors; and an asynchronous communications module configured to facilitate the borrower and one or more creditors to provide asynchronous messages for each other in one or more formats.

Other embodiments concern a method of managing communications between a borrower and one or more creditors. The method can include: using at least one computer processor to receive information regarding one or more approved communications mechanisms from the borrower, the one or more approved communications mechanisms are comprised of allowed methods of communication to the borrower from the one or more creditors; using at least one computer processor to generate one or more appropriate legal notifications to the one or more creditors based upon the approved communication mechanisms; facilitating delivery of the one or more appropriate legal notifications to the one or more creditors using a traceable mechanism; facilitating communications using one or more of the approved communications mechanisms between the one or more creditors and the borrower; using at least one computer processor to receive one or more asynchronous messages from at least one of the one or more creditors to the borrower to the other one via the one or more approved communications mechanisms; and using the at least one computer processor to deliver the one or more asynchronous to the borrower.

Yet further embodiment can concern a communication management system configured to provide bi-directional, third-party hosted communications between two or more parties to one or more binding legal agreements. The communication management system is configured to run on one or more processors, the communication management system can include: a data gathering module configured to run on at least one processor and further configured to receive data from a first party of the two or more parties via a computer network, the data comprises personal data about the first party, information regarding the binding legal agreement, and information regarding the one or more second parties to the binding legal agreement; a decision module configured to run on at least one processor and further configured to provide information to the first party regarding one or more approved communications mechanisms and further configured to receive a selection of one or more selected communications mechanisms from the first party, the one or more selected communications mechanisms comprise allowed methods of communication from the one or more second parties to the one or more binding legal agreements to the first party to the one or more binding legal agreements; a legal notification generation module configured to run on at least one processor and further configured to generate one or more appropriate legal notifications to the one or more second parties to the one or more binding legal agreements based upon the one or more approved communications mechanisms; a legal notification delivery module configured to run on at least one processor and further configured to facilitate delivery of the one or more appropriate legal notifications to the one or more second parties to the one or more binding legal agreements using a traceable mechanism; a second party communications module is further configured to communicate with the one or more second parties to the one or more binding legal agreements via the computer network after the delivery of the one or more appropriate legal notifications to the one or more second parties; a data capture module configured to run on at least one processor and further configured to capture all interactions between the two or more parties that occurred using the communication management system, the data capture module is further configured to facilitate the two or more parties to view a history of all the interactions between the two or more parties captured by the data capture module; a synchronous communications module configured to run on at least one processor and further configured to initiate and capture synchronous communications between the one or more second parties; an asynchronous communications module configured to run on at least one processor and further configured to initiate and capture asynchronous communications directed to one of the two or more parties from another one of the two or more parties; and a compliance module configured to run on at least one processor and further configured to evaluate the responsiveness of each party of the two or more parties in a context of a specific legal agreement of the one or more binding legal agreements.

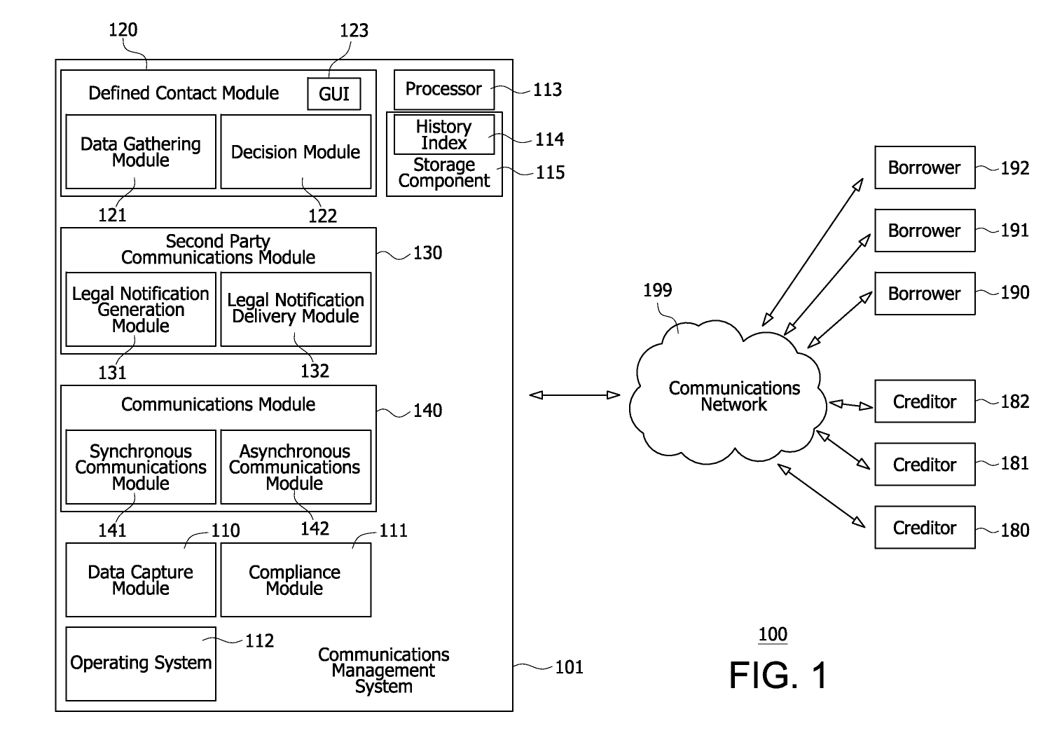

Turning to the drawings, FIG. 1 illustrates a block diagram of a communications management system 100 configured to provide communications between two or more parties to one or more binding legal agreements, according to a first embodiment. In some examples, communications management system 100 and/or 101 can be considered an apparatus configured to provide communications and event tracking between borrowers 190, 191, and 192 and creditors 180, 181, and 182. In the same or different examples, communications management system 100 and/or 101 can be considered a communication management system configured to provide bi-directional, third-party hosted communications between two or more parties to one or more binding legal agreements. Communications management system 100 and/or 101 is merely exemplary and is not limited to the embodiments presented herein. Communications management system 100 and/or 101 can be employed in many different embodiments or examples not specifically depicted or described herein.

Not to be taken in a limiting sense, a simple example of the use of communications management system 101 relates to how two or more parties to a legal agreement can communicate with one another. In one embodiment, communications management system 101 can be implemented to act as an intermediary between multiple parties to a binding legal agreement. For example, the parties to the binding legal agreement can include a first party, which can be a borrower (e.g., borrower 190, 191, or 192), and a second party, which can be creditors (e.g., creditors 180, 181, and/or 182) that has entered into a legal agreement (e.g., a loan agreement, a revolving credit agreement, and/or unpaid bill for products/services) with borrower 190, 191, or 192.

For simplicity, the parties to the legally binding agreement discussed herein will be referred to as creditors and borrowers. However, the embodiments described herein and claims are not just limited to creditors and borrowers but rather can be any party to any legally binding agreement between two or more parties.

Communications management system 101 can allow borrowers 190, 191, and 192 to provide approved communication mechanisms that creditors 180, 181, and 182 can use to contact borrowers 190, 191, and 192 about the borrower's account. For example, borrower 190, 191, or 192 can decide that creditors 180, 181, and 182 can only contact borrower 190, 191, or 192 using communications management system 101. Once borrowers 190, 191, or 192 has provided such information, communications management system 101 can generate and convey appropriate legal notification to creditors 180, 181, and/or 182 using a traceable mechanism (e.g., receiving a confirmation of receipt from creditors 180, 181, and/or 182). Once creditors 180, 181, and/or 182 have received the notification of approved communication mechanisms, that creditor can be compelled to update its internal contact management systems to utilize only the approved communication mechanisms offered by communications management system 101 to communicate with borrowers 190, 191, and/or 192. Communications management system 101 can support many different modes of synchronous and asynchronous communication including, but not limited to, voice mail, call bridging with recording, text messaging, structured question/response, etc. Communications management system 101 can be configured to capture and store any communications and related communication events between borrowers 190, 191, and 192 and creditors 180, 181, and 182. In addition, communications management system 101 can include surveillance and compliance tools to ensure review of non-real time messages between the parties before delivery thereof.

Turning to FIG. 1, in some embodiments, communications management system 101 can include: (a) at least one processor 113; (b) a defined contact module 120 configured to run on processor 113; (c) a second party communications module 130 configured to run on processor 113; (d) a communications module 140 configured to run on processor 113; (e) a data capture module configured to run on processor 113; (f) a compliance module 111 configured to run on processor 113; and (g) an operating system 112 configured to run on processor 113; and (h) a storage component 115 with a history index 114. In some examples, communications management system 101 can be configured to communication with borrowers 190, 191, and 192 and creditors 180, 181, and 182 via a communications network 199 (e.g., the Internet).

Defined contact module 120 can be configured to allow borrowers 190, 191, and 192 to identify approved communications mechanisms. In some examples, the approved communications mechanisms include allowed methods of communication from creditors 180, 181, and 182 to borrowers 190, 191, and 192. In some examples, the allowed methods of communication from the one or more creditors to the borrower can be different for different creditors. For example, one borrower may allow one creditor to only communicate with him using email and this same borrower can let a second creditor contact him via the telephone.

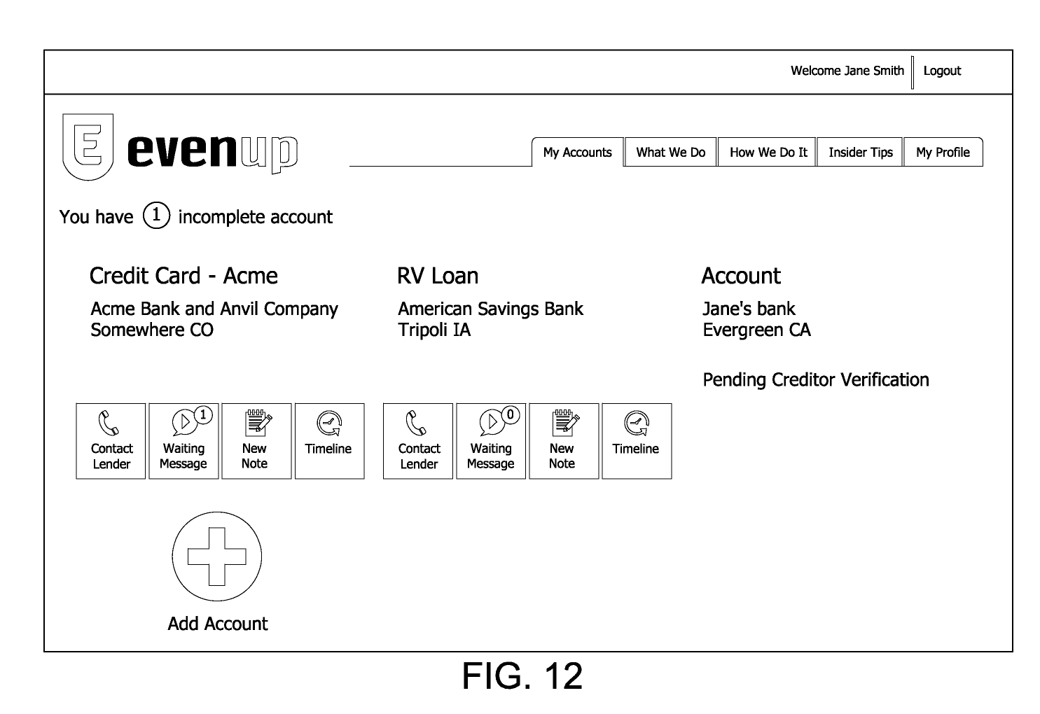

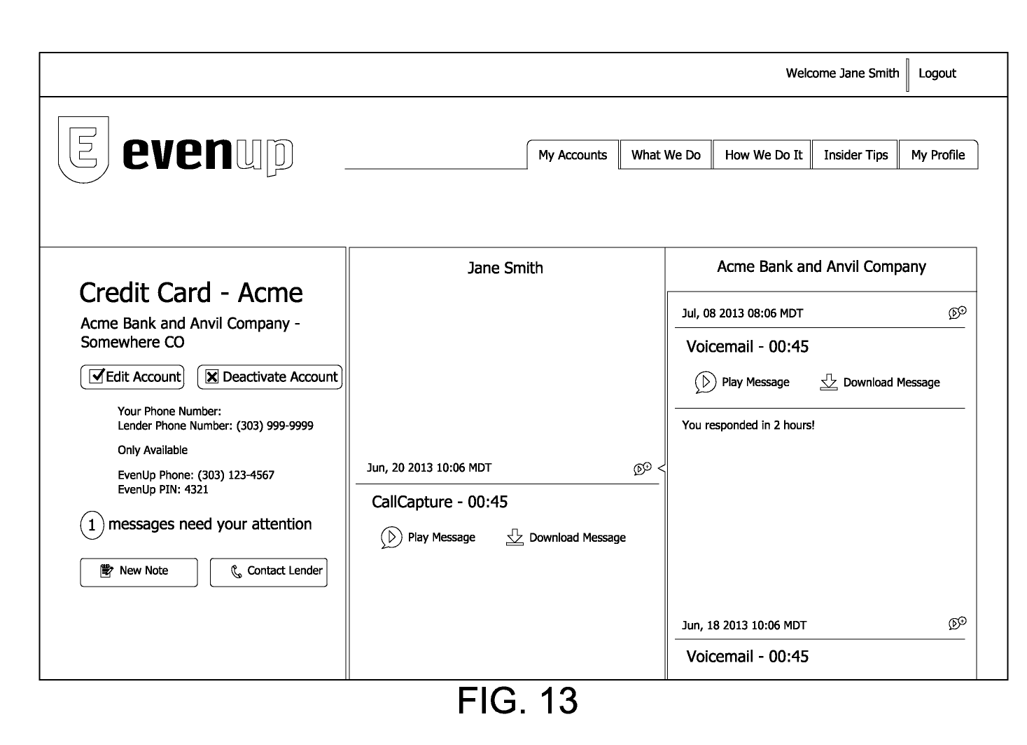

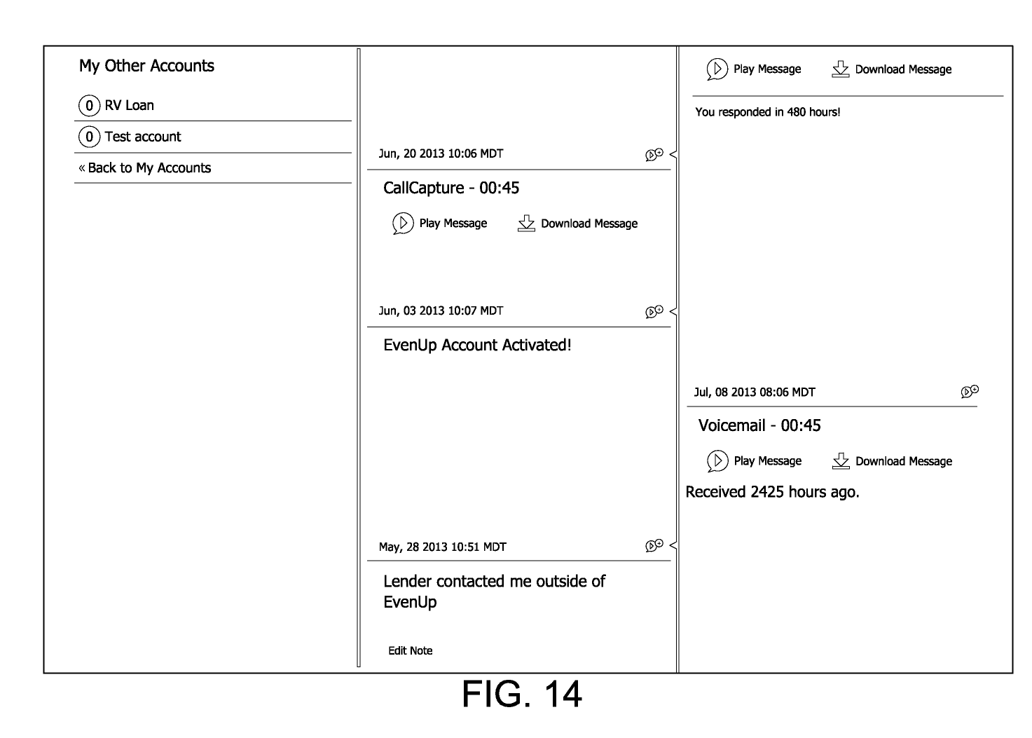

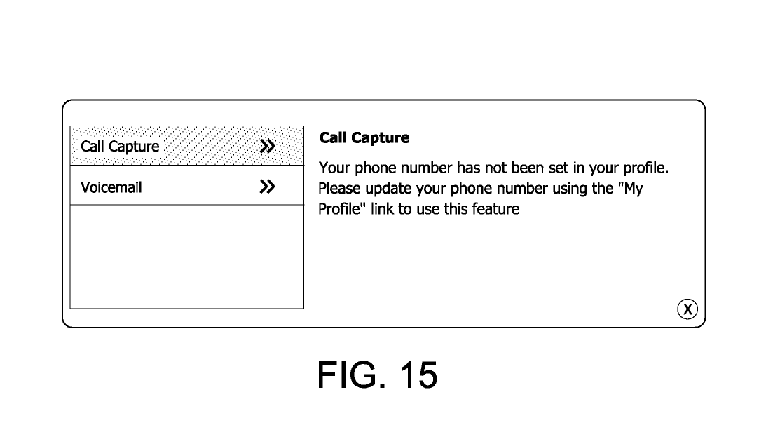

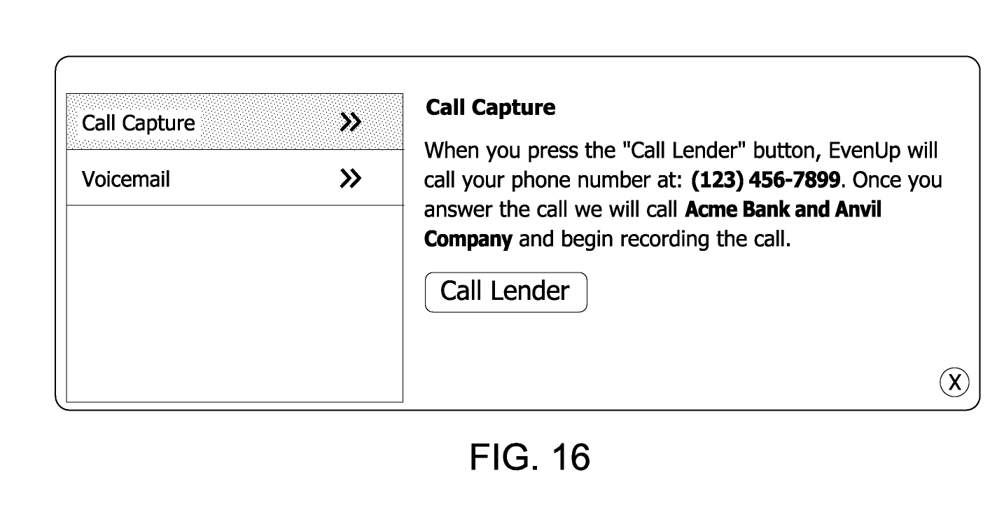

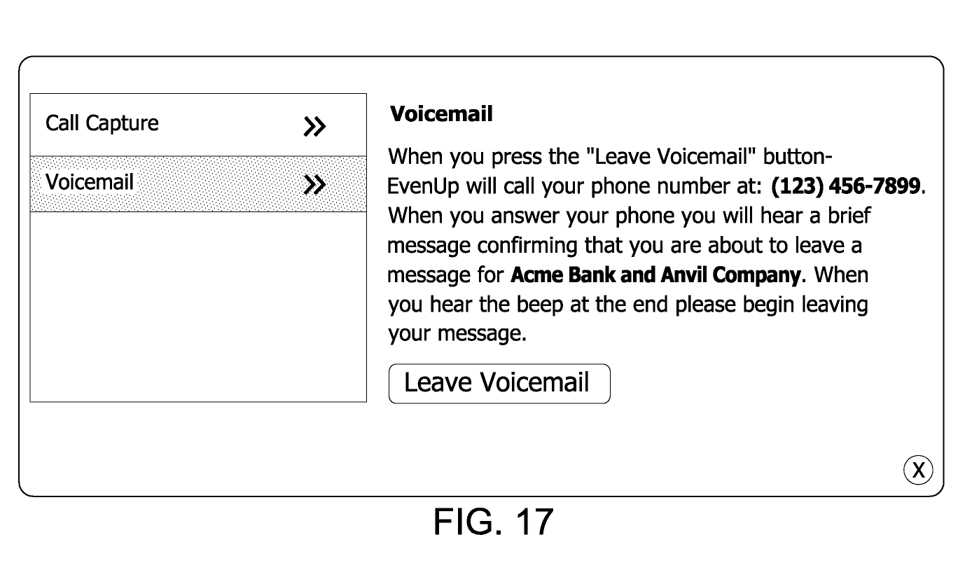

Defined contact module 120 can be configured to communicate to borrowers 190, 191, and 192 through one or more graphical user interfaces (GUIs) 123 and provides the user with options regarding one or more forms of communication with creditors 180, 181, and 182. FIGS. 12-17 provide examples of GUIs that can be used by communications management system 101. In some examples, defined contact module 120 can include: (a) a data gathering module 121; and (b) a decision module 122. In other examples, at least a portion of processes and procedures performed by defined contact module 120 can be performed without use of GUIs.

Data gathering module 121 can be configured to run on processor 113 and further configured to receive data from borrowers 190, 191, and 192 via communications network 199. In some embodiments, the data received can include personal data about borrower 190, 191, or 192, information regarding the binding legal agreement, and information regarding creditors 180, 181, and/or 182.

Decision module 122 can be configured to run on processor 113 and further configured to provide information to borrowers 190, 191, and 192 regarding one or more potential communications mechanisms and further configured to receive the borrower's selection of communication mechanisms.

Second party communications module 130 can be configured to communicate with borrowers 190, 191, and 192 via communications network 199 and other mechanisms (i.e., certified mail or courier service). In various embodiments, second party communications module 130 can include: (a) a legal notification generation module 131; and (b) legal notification delivery module 132.

Legal notification generation module 131 can be configured to run on processor 113 and further configured to generate one or more appropriate legal notifications to creditors 180, 181, and/or 182 based upon the approved communications mechanisms selected by borrower 190, 191, or 192. In some embodiments, legal notification generation module 131 can be configured to generate one or more legal notification letters (e.g., modified cease and desist letters) to creditors 180, 181, and/or 182 based upon the approved communications mechanisms selected by borrower 190, 191, or 192.

Legal notification delivery module 132 can be configured to run on processor 113 and further configured to facilitate the delivery of the one or more appropriate legal notifications to creditors 180, 181, and/or 182 using a traceable mechanism. In some examples, legal notification delivery module 132 can deliver the one or more appropriate legal notifications to creditors 180, 181, and/or 182 via communications network 199. For example, legal notification delivery module 132 can generate and deliver encrypted email containing the appropriate legal notifications to creditors 180, 181, and/or 182. In other examples, legal notification delivery module 132 can facilitate the mailing (via the post office and/or private courier), personal hand delivery of the appropriate legal notifications, or other mechanisms of delivery of the legal notifications.

In some examples, the traceable mechanism can be email delivery with a confirmation receipt and/or acknowledgement, mailing (via the post office and/or private courier) with delivery confirmation, service of the legal notifications consistent with nation, state, or local court laws or rules regarding personal service, hand delivery to a statutory agent for the creditor, and/or other delivery mechanisms agreed to by creditors 180, 181, and/or 182, etc. Other forms of communication can include secure direct interfaces between the computer systems of the creditors and legal notification delivery module 132. Examples could be a secure REST (representational state transfer) interface that returns a confirmation code that proves receipt.

Communications module 140 can be configured to facilitate communication between borrowers 190, 191, and 192 and creditors 180, 181, and 182 using the approved communications mechanisms. In some examples, communications module 140 can encrypt the communications between borrowers 190, 191, and 192 and creditors 180, 181, and 182. Communications module 140 can be further configured to send notifications to the borrower when a message is received for the borrower from the one or more creditors. Communications module 140 can include: (a) a synchronous communications module 141; and (b) asynchronous communications module 142.

Synchronous communications module 141 can be configured to run on processor 113 and further configured to provide real-time communications between borrowers 190, 191, and 192 and creditors 180, 181, and 182. For example, synchronous communications module 141 can facilitate and/or provide a real-time textual connection, a real-time audio connection (e.g., telephone) and/or a real-time audio-visual connection between borrowers 190, 191, and 192 and creditors 180, 181, and 182.

Asynchronous communications module 142 can be configured to run on processor 113 and further configured to facilitate borrowers 190, 191, and 192 and creditors 180, 181, and 182 to provide asynchronous messages for each other in one or more formats. Asynchronous communications module 142 can be further configured such that when one or more asynchronous messages of the asynchronous messages for borrowers 190, 191, and 192 or creditors 180, 181, and 182 are received by the asynchronous communications module 142, asynchronous communications module 142 can notify borrowers 190, 191, and 192 and/or creditors 180, 181, and 182 that asynchronous messages are waiting for them. In some examples, the asynchronous messages can be voice recordings, text messages, email messages, or structured questions/responses.

Data capture module 110 can be configured to capture the communications between borrowers 190, 191, and 192 and creditors 180, 181, and 182. That is, data capture module 110 can be configured to capture all interactions/communications between borrowers 190, 191, and 192 and/or creditors 180, 181, and 182 that occurring using communications management system 101. Data capture module 110 can be further configured to facilitate viewing of a history of all the interactions between the two or more parties captured by data capture module 110.

Compliance module 111 can be configured to ensure review of the asynchronous messages by borrowers 190, 191, and 192 and creditors 180, 181, and 182. That is, compliance module 111 can determine whether borrowers 190, 191, and 192 and creditors 180, 181, and 182 have reviewed any asynchronous messages and report if the asynchronous messages have been reviewed to the sender. Compliance module 111 can be further configured to evaluate the responsiveness of each party of the two or more parties in a context of a specific legal agreement of the one or more binding legal agreements.

“Communications management system 101,” as used herein, can refer to a single computer, single server, or a cluster or collection of servers. Typically, a cluster or collection of servers can be used when the demands by client computers (e.g., borrowers 190, 191, and 192 and creditors 180, 181, and 182) are beyond the reasonable capability of a single server or computer. In many embodiments, the servers in the cluster or collection of servers are interchangeable from the perspective of the client computers.

In some examples, a single server can include defined contact module 120, second party communications module 130, communications module 140, data capture module 110, compliance module 111. In some examples, communications management system 101 can be configured to communication with borrowers 190, 191, and 192 and creditors 180, 181, and 182 via communications network 199 (e.g., the Internet).

In other examples, a first server can include a first portion of these modules. One or more second servers can include a second, possibly overlapping, portion of these modules. In these examples, communications management system 101 can include the combination of the first server and the one or more second servers.

In some examples, storage component 115 can include history index 114. History index 114 store the communications between borrowers 190, 191, and 192 and creditors 180, 181, and 182 captured by data capture module 110.

History index 114 can be a structured collection of records or data, for instance, which is stored in storage component 115. For example, the indexes stored in storage component 115 could utilize an XML (Extensible Markup Language) database, MySQL, an Oracle® database or a NoSQL database or any other appropriate storage/access approach. In the same or different embodiments, the indexes could consist of a searchable group of individual data files stored in storage component 115.

In various embodiments, operating system 112 can be a software program that manages the hardware and software resources of a computer and/or a computer network. Operating system 112 performs basic tasks such as, for example, controlling and allocating memory, prioritizing the processing of instructions, controlling input and output devices, facilitating networking, and managing files. Examples of common operating systems for a computer include Microsoft® Windows, Mac® operating system (OS), UNIX® OS, and Linux® OS.

As used herein, “processor” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions.

In the various examples, borrowers 190, 191, and 192 can communicate with communications management system 101 using remote communications devices. The remote communications devices can include cellular telephone(s), laptop computer(s), tablet computer(s), workstation(s), and telephone(s). In the same or different examples, creditors 180, 181, and 182 can use corporate entity servers or workstations to communicate with communications management system 101. For simplicity, only borrowers 190, 191, and 192 and creditors 180, 181, and 182 are shown in FIG. 1, but communications management system 101 can be configured to communicate with a larger number of creditors and borrowers.

Communications management system 101 can be coupled to remote devices of borrowers 190, 191, and 192 and corporate entity servers of creditors 180, 181, and 182 via communications network 199. In some examples, communications network 199 could be a public domain network of interconnected servers, such as the Internet, a local area network, a wide area network, or a private network using different type of devices capable of interacting with communications management system 101. Communication between borrowers 190, 191, and 192, creditors 180, 181, and 182, and communications management system 101 is not limited to the examples of communications network 199 described above, and can include other present or future wired or wireless mediums.

Communication between borrowers 190, 191, and 192 and communications management system 101 can include the transfer of data, where such data can be entered by a borrower 190, 191, or 192 into data fields appearing on a display screen of a corresponding remote device. The data fields can be generated by a defined contact module 120, communications module 140, and/or another module residing on communications management system 101, and can be transmitted to communications management system 101 via communications network 199. In other examples, the data fields can be generated by a computer application module residing and running on a corresponding remote device of borrowers 190, 191, and 192, where such application module can communicate with communications management system 101 via communications network 199. In some examples, at least a portion of defined contact module 120 and/or communications module 140 can reside and run on a processor of a remote communication device used by borrowers 190, 191, and/or 192.

With respect to the operation of communications management system 101, in one example, a borrower communicating with communications management system 101 via communications network 199 can select or approve one or more convenient forms of communication, which shall be deemed as approved communication mechanisms for creditors 180, 181, and 182 to use to contact borrowers 190, 191, and/or 192. For example, borrower 190, 191, and/or 192 can register with communications management system 101 and declare its relationship with a creditor. For instance, borrowers 190, 191, and/or 192 can select creditors 180, 181, and/or 182 from a list of known creditors in communications management system 101, or add a new creditor to communications management system 101. Borrowers 190, 191, and 192 can then supply the number or identifier of its account with creditors 180, 181, and 182, and select from the available methods of communication to define approved communication mechanisms for that particular creditor. Borrowers 190, 191, and 192 can also accept the terms of service or other agreement(s) that allow communications management system 101 to act as communications agent for borrowers 190, 191, and 192. At this point, second party communications module 130 can queue up the request from borrowers 190, 191, and/or 192 to notify creditors 180, 181, and 182 that borrowers 190, 191, and/or 192 have elected to use communications management system 101 as his or her communications agent.

Legal notification generation module 131 can generate appropriate notifications based on specific data of borrowers 190, 191, and 192, specific data of creditors 180, 181, and 182, and the approved communication mechanisms for creditors 180, 181, and 182. Legal notification generation module 131 can be configured to generate notifications on a defined frequency, which can be immediate, every hour, once a day, once every two days, or another desired time interval.

The information about the approved communication mechanisms from borrowers 190, 191, and 192 could be transmitted to creditors 180, 181, and 182 by legal notification delivery module 132 in the form of a “Modified Cease and Desist” letter (“MCD Letter”). In some examples, the MCD Letter can state that all forms of communication other than the approved communication mechanisms are “inconvenient,” and that only the approved communication mechanisms are for contacting borrowers 190, 191, and 192. The MCD Letter can also notify creditors 180, 181, and/or 182 that borrower 190, 191, or 192 has chosen to rely on communications management system 101 as “communications agent” on behalf of borrowers 190, 191, and 192. Accordingly, borrowers 190, 191, and 192 can control what methods of contact are acceptable while at the same time maintaining open communications with creditors 180, 181, and 182.

In addition, in some embodiments, borrower 190, 191, or 192 can also waive its NPPI (non-public, private information) rights to allow creditors 180, 181, and 182 to leave personal data about borrower/creditor relationship via the approved communication mechanisms. Waiving NPPI rights for the approved communication mechanisms allows creditors 180, 181, and 182 to leave more meaningful and productive messages for borrowers 190, 191, and 192 to review and respond.

Once notifications such as the MCD Letter are generated for delivery to creditors 180, 181, and 182, legal notification delivery module 132 can facilitate delivery of the MCD Letter to creditors 180, 181, and 182 via one or more mechanisms, such as via postal service, express service, electronic transmission, fax, email, or any other suitable mechanism acceptable by creditors 180, 181, and 182. Data capture module 110 can be configured to record the confirmation of delivery of the notification(s) as a communications event, once the notifications are received by creditors 180, 181, and 182. Such confirmation of delivery can be received by communications management system 101 and stored in an event log or timeline of history index 114 for each account and/or for each borrower/creditor relationship.

In some examples, desired interactions between borrowers 190, 191, and 192 and creditors 180, 181, and 182 can be captured and stored as distinct communication events by data capture module 110 in the event log of history index 114. Information about such communication events can be very helpful, for example, when negotiating for a potential settlement. In the same or other examples, such communication events can be used as evidence for a potential legal action if creditors 180, 181, and 182 or borrower has not behaved appropriately.

Data capture module 110 can log all desired communication events in the timeline of history index 114, and can be configured such that, once data has been loaded in the event log, it cannot be modified or deleted by borrowers 190, 191, and 192 and/or creditors 180, 181, and 182. Examples of possible communication events that can be captured in the event log can include the date/time the account was created in communications management system 101, the date/time that the notification or the MCD Letter to creditors 180, 181, and 182 was created, the tracking number for the package sent to creditors 180, 181, and 182, the date/time the notification was received by creditors 180, 181, and 182, the image of the signature of the party that signed for the delivery, and contents of any messages from creditors 180, 181, and 182 to borrowers 190, 191, and 192 and/or from borrowers 190, 191, and 192 to creditors 180, 181, and 182. In various examples, the event log or timeline can be presented in reverse chronological order, but could be presented in other suitable ways such as in chronological order, or organized by type of communication event. In some implementations, all data entered by borrowers 190, 191, and 192 or creditor can be stored by communications management system 101 in a persisted and redundant way (e.g., using secure offsite back-up facilities).

Once the notification has been received by creditors 180, 181, and 182, creditors 180, 181, and 182 can update its appropriate internal systems such as to avoid communicating with borrowers 190, 191, and 192 in a way not authorized by borrowers 190, 191, and 192 in the MCD Letter. Considering that different creditors can have different internal processes, in some examples, communications management system 101 can be configured not to consider a pending account opened by a borrower as fully active until creditors 180, 181, and 182 has used one of the approved communication mechanisms at least once. In such examples, once one or the approved communication mechanisms is used by creditors 180, 181, and 182, communications management system 101 can then consider the pending account as fully active, notify borrowers 190, 191, and 192, and update the event log. Legal notification delivery module 132 can monitor pending accounts to alert borrowers 190, 191, and 192 and/or the manager entity operating communications management system 101 if confirmation of delivery was never received for a notification or MCD Letter sent to creditors 180, 181, and 182, and/or if a fully active account did not receive a message on any of its approved methods of communications from creditors 180, 181, and 182 in a specified period of time (e.g., one day, one week, two weeks, or one month) as defined by the manager entity of communications management system 101.

Communications management system 101 can support and/or facilitate many different methods of communications that can be either synchronous or asynchronous. Asynchronous communications methods can be utilized by either party at any time. Communications management system 101 can support both parties leaving asynchronous messages for one another at the same exact moment or independently in some examples. In the case of synchronous communications methods (e.g. a real-time telephone call or real-time text chat or real-time video conference), communications management system 101 can allow the initiator (usually borrowers 190, 191, and/or 192) to request communications management system 101 to first make a telephone call to borrower 190, 191, and/or 192, then initiate a second telephone call to creditor 180, 181, and/or 182, bridge the call and record the contents of the call. Such recording can be stored as a communication event in the event log for that account. In some implementations, communications management system 101 can store the conversation as either a single recording that contains both sides of the conversation (muxed) or two distinct recordings representing the sounds that came from each side of the conversation.

In the same or different example, communications management system 101 can be configured to allow the borrower to configure his account to ring his telephone number (known by communications management system 101 but not the creditors) if the creditor calls the communications management system 101 to leave a message. In this embodiment, communications management system 101 can facilitate a borrower to enter a time based window (e.g., I would accept real-time calls from this creditor in the window of 2-4 pm). If the creditor calls in that time window—communications management system 101 would ring the borrower's telephone and if the consumer accepts the call by answering their telephone and confirming their desire to talk to the creditor—communications management system 101 would bridge and record the call between the two parties. During this process, the creditor would receive a message that communications management system 101 is attempting to contact the borrower. If the borrower accepts—communications management system 101 bridges and records the call. If the borrower does not answer or refuses to talk to the creditor—communications management system 101 routes the creditor to the borrower's voicemail box to leave a message. Communications management system 101 can be configured to comply with all laws regarding recording of communications between the parties and obtain consent of the parties when appropriate.

When an asynchronous message is left for one of the parties associated with the account, communications management system 101 will create a notification alert for the target party regarding the existence of the new event. This alert could be delivered immediately to the receiving party, or it could be held in a queue waiting for a specific notification time window defined in communications management system 101 by the target recipient (borrowers 190, 191, and/or 192 or creditors 180, 181, and/or 182). This allows either party to leave asynchronous messages at any time without concern of communications management system 101 sending notifications to the recipient at an inconvenient time.

For asynchronous messages, asynchronous communications module 124 can offer an additional capability to screen each message for specific words, phrases and stress levels before the message is actually released to the target party. When an asynchronous message is left in asynchronous communications module 124, based on the configuration for that creditor and borrower, such message can be queued for review before delivery to the target party. The review process could include an electronic review of the stress level implied by the strain in the voice message, the conversion of a voice message to text, a review for inappropriate language (curse words, general foul language) and finally the comparison of restricted words or phrases that are in force for this type of relationship against the content of the message. In other examples, asynchronous communications module 142 can offer an additional capability to screen each message for specific words, phrases and stress levels during real-time communications between the borrower and creditor. In some embodiments, if the screen process determines a potential problem, a flag can be raised, the creditor can be contacted, or other remedies or further analysis can occur.

If a message appears to contain one or more restricted words or phrases, and/or if it has a high level of strain detected in the voice, the message can be automatically routed to a message review queue that is monitored by the operator entity of asynchronous communications module 124. The message review queue of asynchronous communications module 124 can present the message that was received, flag why it was routed to the message review queue, offer the operator entity several options. The operator entity can review the message in its original form, review any translations/conversions thereof by asynchronous communications module 124, and/or review what restricted words/phrases were flagged by asynchronous communications module 124 for the particular message. If the operator entity determines that the screening process failed to properly interpret the message, the message can be released to the target recipient event queue for normal notification processing.

If the message does have questionable content, asynchronous communications module 124 can route the message back to the sender's review queue. The sender can elect to delete the message, edit the message, and/or approve the release of that message to the target recipient. If the sender is not fully integrated with asynchronous communications module 124, and/or if the sender does not review the message queue, the operator entity of communications module 140 can make an attempt to contact the sender to review the message to determine how they want that message handled. If the sender cannot be reached within a defined period of time, communications management system 101 can release the message to the recipient's message review queue for normal processing. Once a message has been released to the recipient, asynchronous communications module 124 may not allow for that message to be deleted or recalled.

Asynchronous communications module 124 can also offer a structured question/response system that guides a party to help them understand the motivations and options that the other party can have with regard to resolving a conflict between both parties. In the example of a creditor and borrower, such feature could ask questions about the loan type (auto, boat, unsecured credit, etc.) and, based on the response, ask additional questions about the loan, payment history, and about the reason why borrowers 190, 191, and 192 has missed payments. Asynchronous communications module 124 can then present borrowers 190, 191, and 192 with possible solutions that could be acceptable to creditors 180, 181, and 182. The structured question/response system of asynchronous communications module 124 can determine subsequent questions based responses prior questions. Question scenarios can vary based on legal relationship between the parties, the type of agreement between the parties, and specific information about borrowers 190, 191, and 192 or creditors 180, 181, and 182.

As the parties interact using asynchronous communications module 124, new messages and responses to those messages are generated by the parties and stored by asynchronous communications module 124 as communication events. Each time a new message or response to a message is created, data capture module 110 can tabulate statistics on many elements of the interactions between the two parties. As an example, data capture module 110 could monitor the number of messages, the number of responses, the depth of content in the messages, the time between receipt of a message and the response to that message and the overall outcome of negotiations (which can be likely assisted by the question/response system described above). Such information can be combined by compliance module 111 to generate a response score with respect to the responsiveness and/or cooperation level of each party throughout the different communications there between. In the case of a creditor/borrower relationship, the “response score” for borrowers 190, 191, and 192 can reflect, for example, how quickly borrowers 190, 191, and 192 picked up messages, responded to those messages and the final outcome of the relationship (account written off, account paid off, etc.).

In some examples, the ability to generate response scores for parties using communications management system 101 can be used to gather information not otherwise available via normal credit industry channels. In the credit industry, individual consumers receive a credit rating that is based on their past activity in the markets. That credit rating is based on the total number of dollars that is actively in use by the consumer, the unused credit dollars already granted, and on the history of their payments against those loans (including late payments history). This rating system is dependent on receiving updates from the individual creditors and, therefore, the timing and logic behind the reporting of such credit updates is not consistent. Credit ratings are thus, by definition, lagging with respect to the current the status of borrowers 190, 191, and 192.

The response scoring system made possible by the use of a communication management system like communications management system 101 takes a different approach. Since communications management system 101 is directly involved in every interaction between creditors 180, 181, and 182 and borrowers 190, 191, and 192 in real time, the responsiveness of the interactions between the parties can be measured in real time as they are occur. This timing is critical to understand the current situation or willingness of a borrower to resolve their debts.

As described herein, communications management system 101 captures interactions between borrowers 190, 191, and 192 and creditors 180, 181, and 182 as communication events, which can be of a specific type based on what their contents are. Such an approach allows communications management system 101 to accommodate new types of interactions without major adjustments, and also allows the response scoring system to be immediately able to handle the addition of new event types. The response scoring system assigns an importance weight to the user's response to a particular type of communication event as part of its calculations. Some events will not have impact on the response score (e.g. notification of statement delivered from creditor). An event type table can list all known events, can list whether specific events impact the response scoring calculation and, if they do, can list how much individual subscores of the response scoring are incremented or decremented.

The response scoring system takes a holistic view of borrowers 190, 191, and 192 and its interactions with creditors. The response rating is driven by the responsiveness of users, the results of their interactions, and the disposition of the account. The response score for a user can be calculated by communications management system 101 at the individual relationship level (an account with a creditor) as well as across all creditors/accounts that user has with communications management system 101. In some examples, the response scoring system can also take into account a credit score or FICO score of an individual.

Each time communications management system 101 processes a new event for a user, communications management system 101 will determine if it should recalculate the response scoring for that user at that moment. In some examples, communications management system 101 will recalculate the response scoring each day whether not a new event has been processed for a user. The response score can be presented to the user when accessing communications management system 101.

In one implementation, the response scoring system can have a maximum score of 100 and can include three subscores such as a timeliness subscore regarding how quickly the user picks up messages, an interactions result subscore, and a final disposition subscore. For instance, the timeliness subscore can include a maximum of 40 points, the interactions result subscore can include a maximum of 40 points, and the final disposition subscore can include a maximum of 20 points, all adding up to the maximum score of 100. In other examples, other ranges of scores can be assigned to each respective subscore of the response scoring system.

As an example of one possible implementation of the response scoring system, when a borrower signs up for service with communications management system 101 and its account becomes fully active after creditors 180, 181, and 182 begins using communications management system 101, the response scoring can begin for borrowers 190, 191, and 192. For instance, borrowers 190, 191, and 192 can be granted an initial response score of 80 split amongst the different subscores of the response scoring system. For example, the initial response score can include 30 points for the timeliness subscore, 30 points for the interactions results subscore, and 20 points for the final disposition of the account subscore.

With respect to the timeliness subscore of the response scoring system, communications management system 101 will notify borrowers 190, 191, and/or 192 that a message is waiting during the next available event notification window. Once that notification has been sent out, communications management system 101 will monitor how long it takes for borrower 190, 191, and/or 192 to enter the system and review the message. For example, if the message is reviewed within four hours of borrower 190, 191, and/or 192 being notified, borrower 190, 191, and/or 192 can receive two points toward its timeliness subscore. If borrower 190, 191, and/or 192 reviews the message within one day, borrower 190, 191, and/or 192 can receive one point toward his timeliness subscore. If it takes more than a day but less than two days to review, the timeliness subscore will not be changed. If it takes more than two days, borrower 190, 191, and/or 192 can lose one point from its timeliness subscore for each additional day it takes to review the message.

With respect to the interaction subscore, once borrower 190, 191, and/or 192 has received and reviewed a message from creditors 180, 181, and/or 182, borrower 190, 191, and/or 192 needs to respond to the message and work to find a resolution. As an example, if borrower 190, 191, and/or 192 reviews a message and then elects to leave a message back to creditors 180, 181, and/or 182, borrower 190, 191, and/or 192 can receive one point toward its interaction subscore after successfully leaving the message. If borrower 190, 191, and/or 192 receives multiple messages from creditors 180, 181, and/or 182 and only reviews but does not respond to that message, borrower 190, 191, and/or 192 can lose one point in the interaction subscore for each unresponded message after the first. If borrower 190, 191, and/or 192 utilizes the “promise to pay” capability of communications management system 101, borrower 190, 191, and/or 192 they will immediately receive 1 point in the interaction subscore. If borrower 190, 191, and/or 192 actually does pay as promised, they will receive one additional point (the receipt of the payment by creditors 180, 181, and 182 is just another event that communications management system 101 records). If they make a promise to pay and they do not actually pay on time, the interaction subscore can be reduced by two (one to take away the point they earned by entering the promise to pay and the second point as a fine for missing the promise).

In some examples, the promise to pay feature of communications management system 101 can involve communications management system 101 receiving account data from the creditor as, for example, metadata that could include how many days the creditor is willing to let borrowers use the automated promise to pay feature in communications management system 101. That data would include the maximum date that the creditor is willing to extend (usually two weeks)—the minimum amount the creditor would accept in the promise to pay (usually 90% of the normal payment). In the embodiments, if the borrower is late on their payment—communications management system 101 would receive a daily data file from the creditor that would tell communications management system 101 that this account is late—communications management system 101 can generate a new event in communications management system 101 using the data from the creditor and a template approved by the creditor to present a dunning notice by communications management system 101. The automatic notification process would alert the borrower that a message was waiting. Once the borrower reviews the message the borrower will have the option to click on a Promise to Pay and that will ask the borrower what date he will pay, how much he will pay and why he was late. If the borrower enters terms that are agreeable to the terms established in the file by the creditor—communications management system 101 would accept the request by the borrower on behalf of the creditor and then send the details to the creditor via a REST call or a nightly file.

With respect to the final disposition subscore, if borrower 190, 191, and/or 192 is making timely payments on the account, each payment could add one point to their final disposition subscore. If borrower 190, 191, and/or 192 is missing payments, each missed payment can subtract one point from the final disposition subscore. If borrower 190, 191, and/or 192 defaults on the account, the final disposition subscore can be set to zero. If borrower 190, 191, and/or 192 goes to settlement with creditors 180, 181, and/or 182, the final disposition subscore can decrease by ten points, but if borrower 190, 191, and/or 192 then continues to pay the settlement payments on schedule, the final disposition subscore will receive one point for each payment that is made on time Note that each category of scoring cannot exceed the available range for the scoring component. In this example, the “responsiveness” score can range from 0-30. Even if the borrower generates an abundance of points for this category—their balance will never exceed 30.

In some implementations, a weighted average can be used to calculate the combined response score for a borrower that has more than one relationship in communications management system 101. For instance, the weighted average of borrowers' different response scores for each relationship in communications management system 101 can be weighted by how long the corresponding relationship existed in communications management system 101. As an example, for a borrower that has used communications management system 101 for relationship A (duration=18 months, response score=88) and relationship B (duration=9 months, response score=95), the resulting combined response score would be 90.33 ((88*18+95*9)/(18+9)).

In some embodiments, a blended score can be generated by modifying borrower's credit or FICO score based on its response score, or vice-versa. For instance, the FICO score of borrowers 190, 191, and 192 can be multiplied by borrower's current combined response score divided by 85.

As an example, if a borrower has an overall response score of 80 and a FICO score of 620, the blended score would be 584 (620*(80/85)). This shows that borrower's current actions in communications management system 101 has shown that borrowers 190, 191, and 192 is not being as responsive as it should be, and therefore communications management system 101 has discounted borrower's FICO score with the real-time knowledge of the user's interactions.

As another example, if a borrower user has an overall response score of 85 and a FICO score of 620, the blended score would be 620 (620*(85/85)). This shows that borrower's current actions in communications management system 101 show that borrowers 190, 191, and 192 is being somewhat responsive, and therefore communications management system 101 makes no adjustment to borrower's FICO score based on the real-time knowledge of borrower's interactions.

As yet another example, if a borrower has an overall response score of 95 and a FICO score of 620, the blended score would be 693 (620*(95/85)). This shows that borrower's current actions in communications management system 101 show that borrowers 190, 191, and 192 is being very responsive, and therefore communications management system 101 enhances the FICO score with the real-time knowledge of the user's interactions.

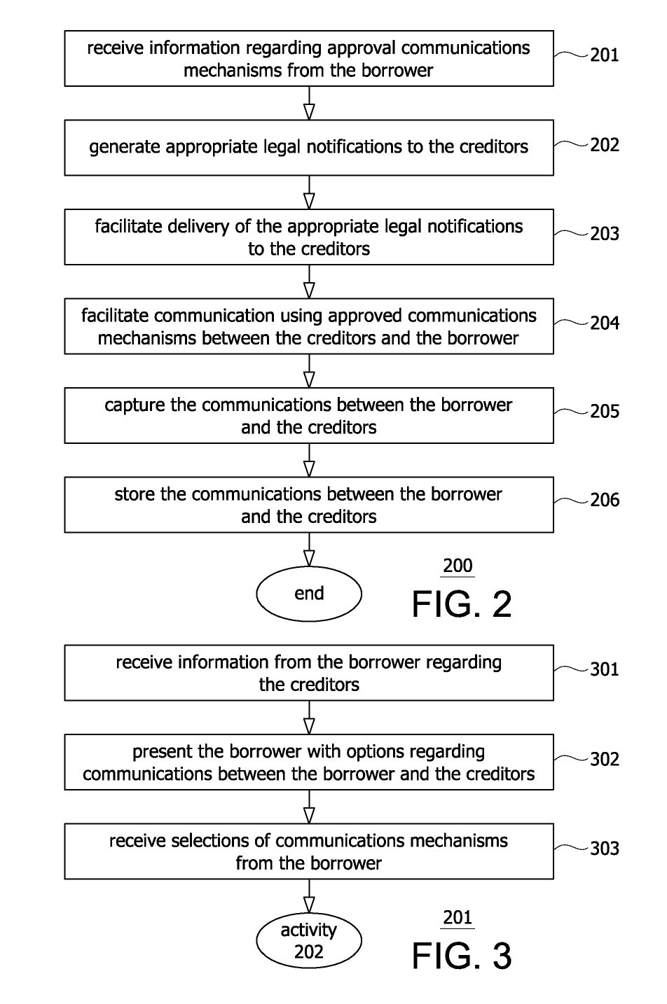

FIG. 2 illustrates a flow chart for an embodiment of a method 200 of managing communications between a borrower and one or more creditors. Method 200 is merely exemplary and is not limited to the embodiments presented herein. Method 200 can be employed in many different embodiments or examples not specifically depicted or described herein. In some embodiments, the activities, the procedures, and/or the processes of method 200 can be performed in the order presented. In other embodiments, the activities, the procedures, and/or the processes of method 200 can be performed in any other suitable order. In still other embodiments, one or more of the activities, the procedures, and/or the processes in method 200 can be combined or skipped.

Referring to FIG. 2, method 200 includes an activity 201 of receiving information regarding approved communications mechanisms from the borrower. In some examples, activity 201 includes using at least one computer processor to receive information regarding one or more approved communications mechanisms from the borrower. The approved communications mechanisms include allowed methods of communication to the borrower from the one or more creditors. In some examples, data gathering module 121 of FIG. 1 can perform at least part of activity 201. FIG. 3 illustrates a flow chart for an exemplary embodiment of activity 201 of receiving information regarding approved communications mechanisms, according to the first embodiment.

Referring to FIG. 3, activity 201 includes a procedure 301 of receiving information from the borrower regarding one or more creditors of the borrower. In some examples, the borrower can input names of his creditors, his account numbers, and/or other information about his relationship with the creditors.

Next, activity 201 includes a procedure 302 of presenting the borrower with options regarding communications between the borrower and the creditors. In some examples, procedure 302 can include using at least one computer processor to present the borrower with one or more options regarding communications between the borrower and one or more creditors. In some examples, data gathering module 121 can present one or more options to the borrower on GUI 123. For example, the borrower can be presented with the option to receive communications from the creditors via telephone, email, and/or text messages. Furthermore, the borrower can be presented with one or more options regarding the time frames (i.e., only between 5 pm and 8 pm local time or only on weekends) when the creditors can contact the borrower.

Subsequently, activity 201 of FIG. 3 includes a procedure 303 of receiving selections of communications mechanism(s) from the borrower. In some examples, procedure 303 can include using at least one computer processor to receive one or more selections of communications mechanisms from the borrower based upon the one or more options regarding communications between the borrower and the one or more creditors. In some examples, decision module 122 can receive the options from the borrower and communicates the options to second party communications module 130. After procedure 303, activity 201 is complete. In this procedure, the borrower selects the communication options with each of the one or more creditors (e.g., the only communication that is allowed is telephone calls between 5 pm and 8 pm local time via communications management system 101 or only by text messages via communications management system 101).

Method 200 in FIG. 2 continues with an activity 202 of generating appropriate legal notifications to the creditors. In some examples, activity 202 can include using the at least one computer processor to generate one or more appropriate legal notifications to the one or more creditors based upon the approved communication mechanisms. In some examples, activity 202 can include using at least one computer processor to generate one or more modified cease and desist letters to one more creditors based upon the approved communications mechanisms. In various embodiments, legal notification generation module 131 can perform activity 202.

Subsequently, method 200 of FIG. 2 includes an activity 203 of facilitating delivery of the appropriate legal notifications to the creditors. In some examples, activity 203 can include facilitating delivery of the one or more appropriate legal notifications to the one or more creditors using a traceable mechanism. In some examples, legal notification delivery module 132 can perform activity 203 using one of the notification methods previously discussed.

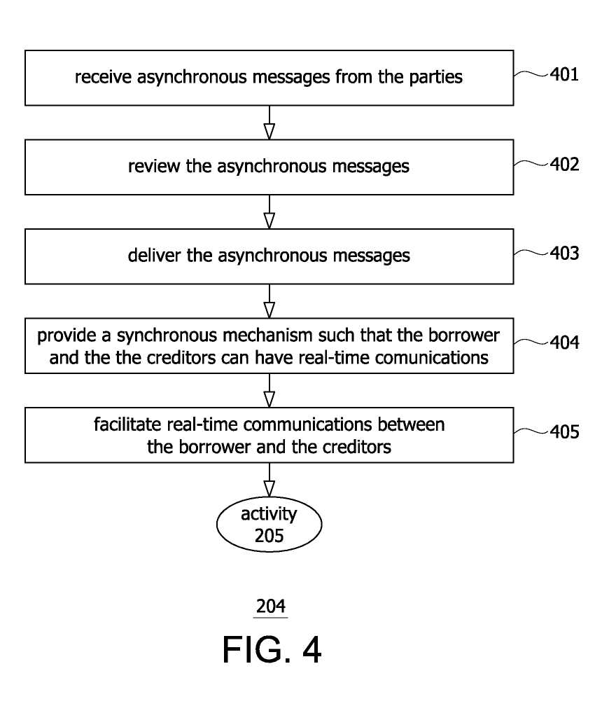

Next, method 200 of FIG. 2 includes an activity 204 of facilitating communication using the approved communications mechanisms between the creditors and the borrower. In some examples, second party communications module 130 can perform at least part of activity 204. FIG. 4 illustrates a flow chart for an exemplary embodiment of activity 204 of facilitating communication using the approved communications mechanisms between the creditors and the borrower, according to the first embodiment.

Referring to FIG. 4, activity 204 includes a procedure 401 of receiving asynchronous messages from the parties. In some examples, procedure 401 can include using at least one computer processor to receive one or more asynchronous messages from the creditors to the borrower via the one or more approved communications mechanisms. In the same or different examples, procedure 401 can include using at least one computer processor to receive one or more asynchronous messages from the borrower to the creditors via the one or more approved communications mechanisms. In some examples, asynchronous communications module 142 can perform procedure 401.

Activity 204 in FIG. 4 continues with a procedure 402 of reviewing of the asynchronous messages. In some examples, asynchronous communications module 142 can review the asynchronous messages as previously discussed.

Subsequently, activity 204 of FIG. 4 includes a procedure 403 of delivering the asynchronous messages. In some examples, procedure 403 can include using at least one computer processor to deliver the one or more asynchronous to the borrower. In the same or different examples, procedure 403 can include using the at least one computer processor to deliver the one or more asynchronous to the creditors. In various embodiments, procedure 403 can include using at least one computer processor to receive at least one of a voice recording, a text messages, an email message, and/or one or more structured questions from the one or more creditors to the borrower. In some examples, asynchronous communications module 142 can perform procedure 403.

Furthermore, in various examples, asynchronous communications module 142 can also ensure review of the asynchronous messages by the borrower and/or the creditors as part of procedure 403.

Activity 204 of FIG. 4 also includes a procedure 404 of providing a synchronous communication mechanism such that the borrower and the creditors can have real-time communications. In various examples, synchronous communications module 141 can provide the synchronous communication mechanism as previously discussed.

Activity 204 in FIG. 4 continues with a procedure 405 of facilitating real-time communications between the borrower and the one or more creditors. In various examples, synchronous communications module 141 can facilitate the synchronous communication mechanism as previously discussed. After procedure 405, activity 204 is complete.

Method 200 in FIG. 2 continues with an activity 205 of capturing the communications between the borrower and the creditors. In some examples, activity 205 can include using at least one computer processor to capture the communications between the borrower and the creditors and/or using at least one computer processor to determine any communication between the borrower and the creditors is using the one or more approved communications mechanisms. In some examples, data capture module 110 and/or compliance module 111 can perform at least part of activity 205.

Method 200 in FIG. 2 continues with an activity 206 of storing the communications between the borrower and the creditors. In some examples, activity 206 can include storing the communications between the borrower and one or more creditors in non-volatile memory. In various embodiments, the communications can be stored in storage component 115 and/or history index 114. After activity 206, method 200 is complete.

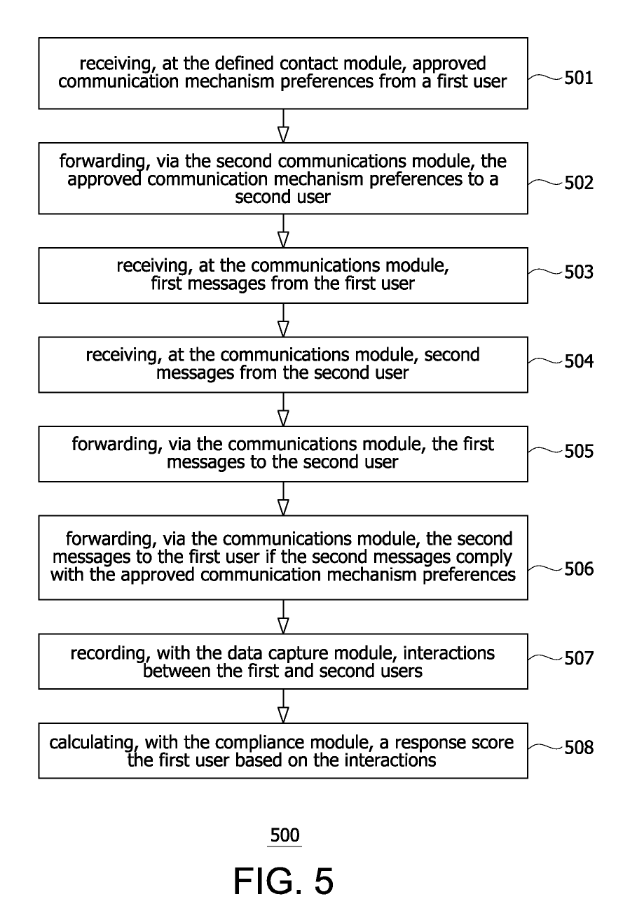

FIG. 5 illustrates a flowchart for a method 500 for using a communications management system. Method 500 is merely exemplary and is not limited to the embodiments presented herein. Method 500 can be employed in many different embodiments or examples not specifically depicted or described herein. In some embodiments, the activities, the procedures, and/or the processes of method 500 can be performed in the order presented. In other embodiments, the activities, the procedures, and/or the processes of method 500 can be performed in any other suitable order. In still other embodiments, one or more of the activities, the procedures, and/or the processes in method 500 can be combined or skipped.

Method 500 of FIG. 5 includes an activity 501 for receiving, at defined contact module 120, approved communication mechanism preferences from a first user. In some examples, the first user can be a borrower, and the approved communication mechanism can correspond to one of the communications mechanisms described above as options for approval by the borrower. The information received can include information used to generate an MCD Letter for delivery to the creditors.

Activity 502 of method 500 of FIG. 5 involves forwarding, via the second party communications module 130, the approved communication mechanism preferences to the second user. In some examples, the second user can be a creditor.

Activity 503 of method 500 of FIG. 5 includes receiving, at communications module 140, first messages from the first user. The first messages can correspond to communications from the borrowers intended for the creditors.

Activity 504 of method 500 of FIG. 5 includes receiving, at communications module 140, second messages from the second user. In some examples, the second messages can be from the creditors and intended for the borrower regarding the status of, or negotiations regarding, the borrower's loan.

Activity 505 of method 500 of FIG. 5 includes forwarding, via communications module 140, the first messages to the second user.

Activity 506 of method 500 of FIG. 5 includes forwarding, via communications module 140, the second messages to the first user if the second messages comply with the approved communication mechanism preferences. If one or more of the second messages do not conform to the approved communication mechanism preferences selected by the first user, the second user can be notified accordingly for review of such non-conforming second messages.

Activity 507 of method 500 includes recording, with data capture module 110, interactions between the first and second users. In some examples, the interactions recorded can include the time, frequency, and content of messages sent back and forth between the first and second users.

Activity 508 of method 500 includes calculating, with compliance module 111, a response score for the first user based on the interactions recorded in Activity 507. In some examples, activities 507-508 can be optional.

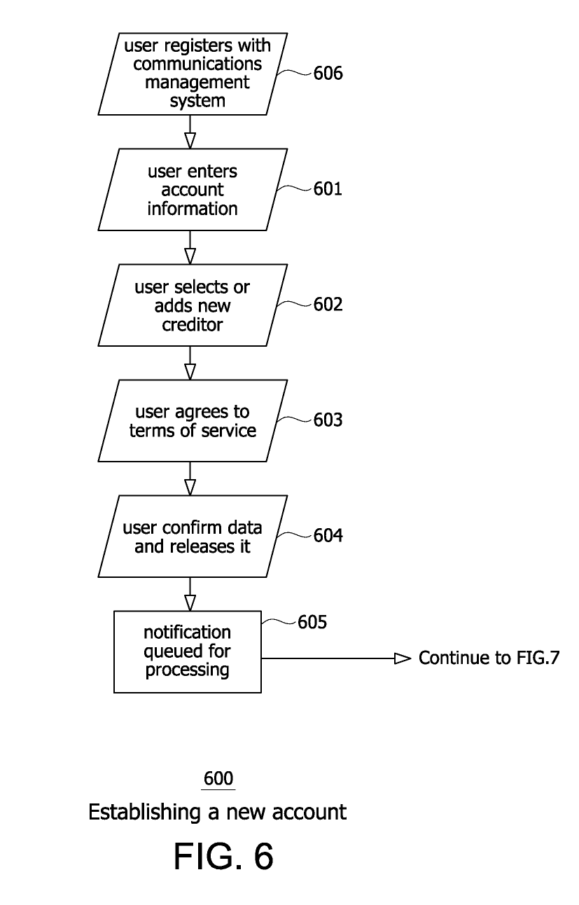

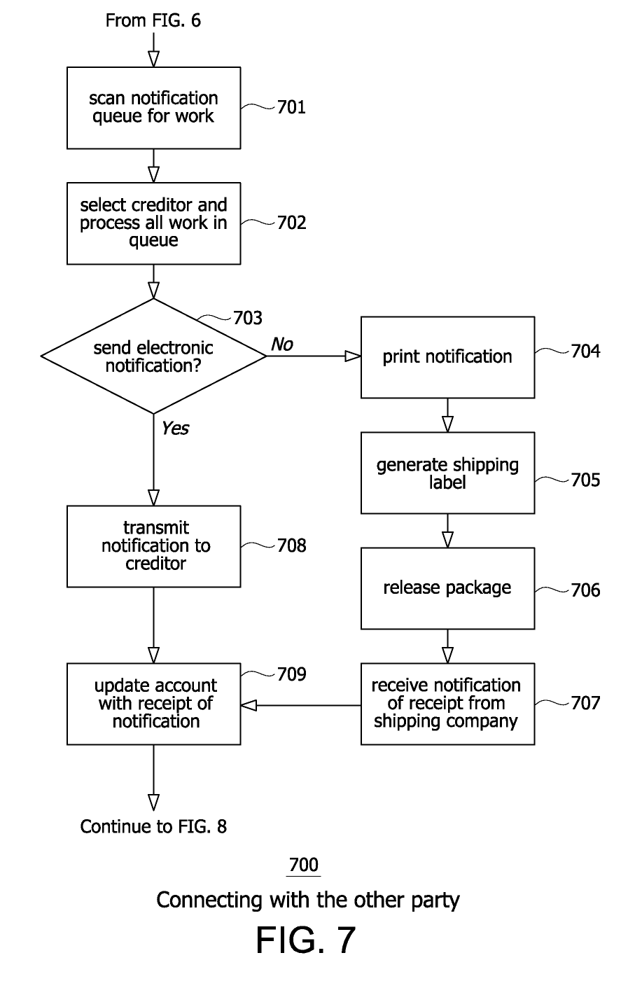

FIGS. 6-11 illustrate exemplary flowcharts for the operation or use of communications management system 101 via communications network 199. In some examples, the methods of FIGS. 6-11 can be used to implement communications management system 101 (FIG. 1), and/or one or more features or aspects of methods 200 and 500 as described above with respect to FIGS. 2-5.

FIG. 6 illustrates a flowchart for method 600 of establishing a new account with communications management system 101. Method 600 is merely exemplary and is not limited to the embodiments presented herein. Method 600 can be employed in many different embodiments or examples not specifically depicted or described herein. In some embodiments, the activities, the procedures, and/or the processes of method 600 can be performed in the order presented. In other embodiments, the activities, the procedures, and/or the processes of method 600 can be performed in any other suitable order. In still other embodiments, one or more of the activities, the procedures, and/or the processes in method 600 can be combined or skipped.

In activity 606, a user registers with communications management system 101 using its respective remote device. Every user is generally a party to at least one legal agreement. For the present example, the user in activity 606 can be a borrower. The registration process includes the user providing information such as contact information (phone number, street address, electronic mail address) and account details. In addition, upon registration, the user can provide evidence for future secure use, such as username, password, and a digital signature. The user information is stored by communications management system 101.

In activity 601, after registering, borrowers 190, 191, and/or 192 can define a new relationship with a particular creditor with whom they have entered a legal agreement. In some examples, borrowers 190, 191, and 192 can enter the name for the relationship or account. Borrowers 190, 191, and 192 can also declare what type of credit was utilized (e.g. auto loan, unsecured credit, student loan, etc.).

In activity 602, borrowers 190, 191, and 192 can search the known creditor list to see if creditors 180, 181, and 182 are already listed in a database of communications management system 101. If it is an approved creditor, borrowers 190, 191, and 192 can then select creditors 180, 181, and 182. If creditors 180, 181, and 182 are not present in the list, borrowers 190, 191, and 192 can propose a new creditor by adding creditor's contact information (entity name, address, phone number, etc.) to communications management system 101. That proposed creditor can be evaluated by communications management system 101 for approval. Borrowers 190, 191, and 192 can also enter the account number used by their creditor to identify the specific account for which borrowers 190, 191, and 192 wishes to utilize communications management system 101.

In activity 603, borrowers 190, 191, and 192 reviews and accepts the terms of service for communications management system 101.

In activity 604, borrowers 190, 191, and 192 can review the entered to confirm its accuracy. In some embodiments, borrowers 190, 191, and 192 could also be asked to pay for using communications management system 101.

In activity 605, borrowers 190, 191, and 192 have completed the initiation of the relationship. The notification for using communications management system 101 as a communications agent for borrowers 190, 191, and 192 is placed in a queue for processing. An event is created in the even log using the current system date/time.

In some implementations, an event can represent any activity that can occur in the context of the relationship between creditors 180, 181, and 182, borrowers 190, 191, and 192, and communications management system 101. Example events can include: account creation, notification generated, notification shipped, notification receipt acknowledged, voice message received/sent, phone call recorded, account statement received, text message received/sent, promise to pay created, etc.

The information gathered from borrowers 190, 191, and 192 is received by communications management system 101 from the respective remote devices or other connected servers used by borrowers 190, 191, and/or 192. Such information is preferably stored by communications management system 100 into a database thereof and/or in a remote database.

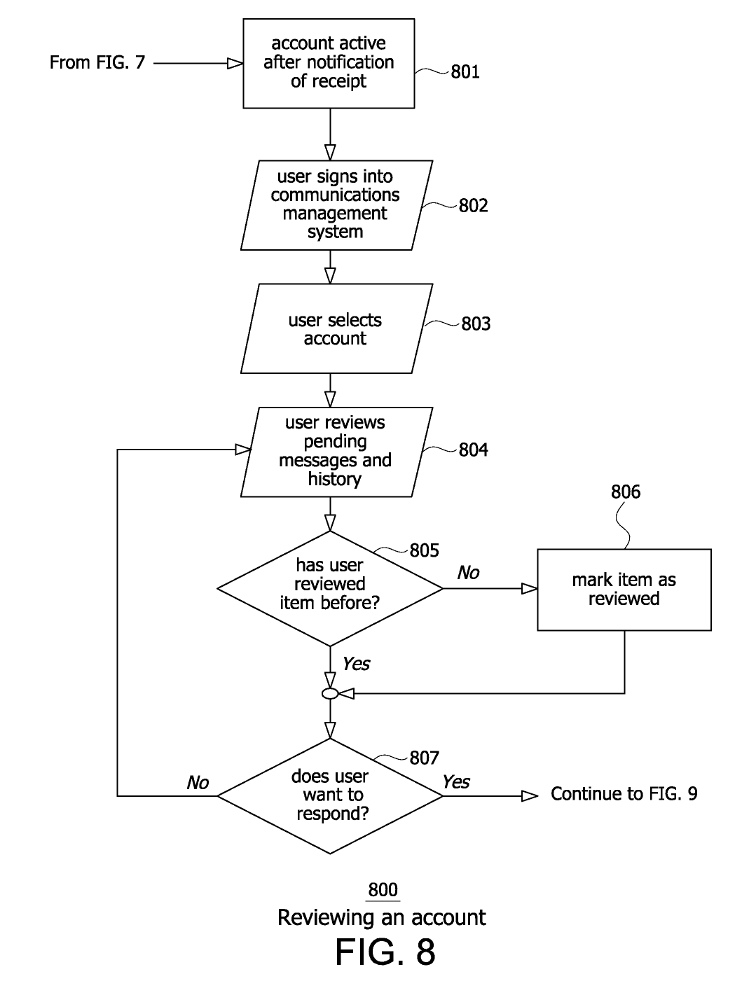

FIG. 7 illustrates a flowchart for method 700 of connecting with creditors 180, 181, and 182. Method 700 is merely exemplary and is not limited to the embodiments presented herein. Method 700 can be employed in many different embodiments or examples not specifically depicted or described herein. In some embodiments, the activities, the procedures, and/or the processes of method 700 can be performed in the order presented. In other embodiments, the activities, the procedures, and/or the processes of method 700 can be performed in any other suitable order. In still other embodiments, one or more of the activities, the procedures, and/or the processes in method 200 can be combined or skipped.

In activity 701, processor 113 can scan its queue to determine if there are new notifications to generate for creditors. Criteria for when to generate such notifications can be determined by parameters set by the operator entity of communications management system 101. As an example, possible parameters could include the maximum allowed time for a notification to sit in the queue before generation occurs (e.g., 12 hours). Activity 701 can be reached from activity 605 of method 600 (FIG. 6)

In activity 702, the queue scanning process can process the queue, such as by grouping the required work by creditor such that all pending notifications for a particular creditor can be processed together.

In activity 703, legal notification delivery module 132 can determine whether creditors 180, 181, and 182 entered by borrowers 190, 191, and 192 supports electronic notification. If it does support electronic notification, the next activity is activity 708. Otherwise, the next activity is activity 704.

Activity 704 is reached if creditors 180, 181, and 182 do not support electronic notification. Legal notification delivery module 132 can generate a hard-copy notification by printing to the appropriate printer.

In activity 705, legal notification delivery module 132 can contact the preferred shipping company to generate a shipping label along with any needed manifests to create a complete package for delivery to creditors 180, 181, and 182. In some examples, the shipping company can support electronic confirmation of package delivery. In other examples, legal notification delivery module 132 can generate the shipping label along with any needed manifests.

In activity 706, the package is released into the shipping company for delivery.

In activity 707, any interim shipping status updates will be collected by data capture module 110 and added to the event log (e.g. package enters shipping system, package progress inside the shipping system, etc.). Communications management system 101 will monitor the activity of a package until it receives notification that the package was delivered along with signature information. If the package tracking stops before communications management system 101 receives notification of delivery, communications management system 101 can notify its operator entity of communications management system 101 of the problem.

In activity 709, communications management system 101 has received an update that creditors 180, 181, and 182 has confirmed receipt of the notification, and can create an event in the event log with such information. Communications management system 101 can also create a timer to check with borrowers 190, 191, and 192, after a predetermined amount of time, whether the unapproved methods of communications have stopped. Such predetermined amount of time can be specific for each creditor.

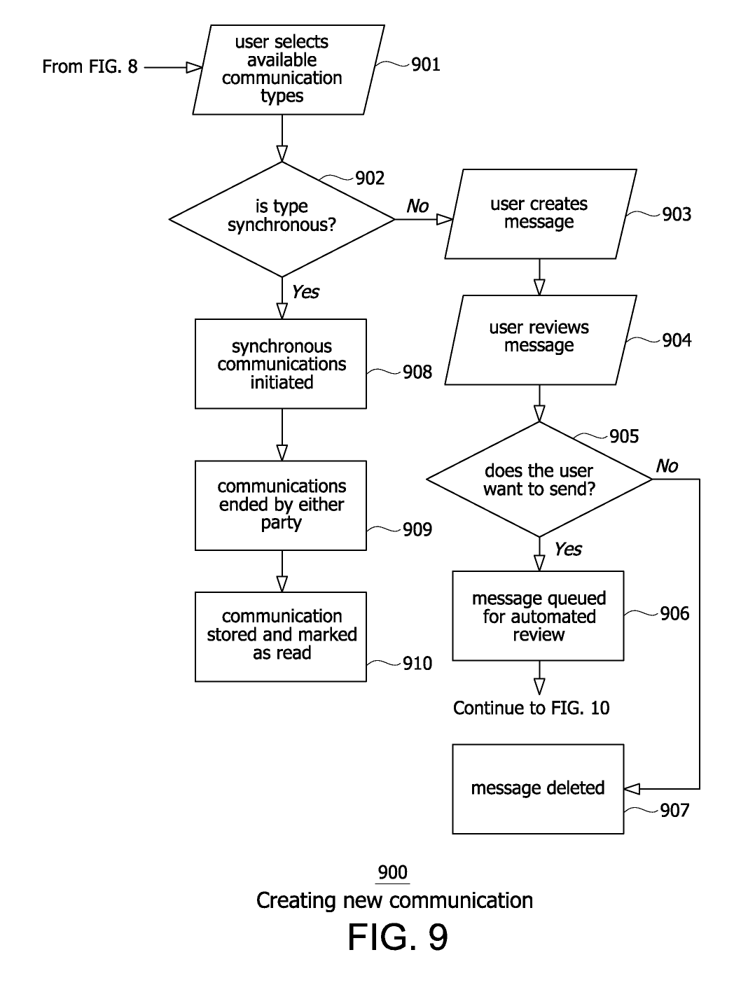

FIG. 8 illustrates a flowchart for method 800 of reviewing an account. Method 800 is merely exemplary and is not limited to the embodiments presented herein. Method 800 can be employed in many different embodiments or examples not specifically depicted or described herein. In some embodiments, the activities, the procedures, and/or the processes of method 800 can be performed in the order presented. In other embodiments, the activities, the procedures, and/or the processes of method 800 can be performed in any other suitable order. In still other embodiments, one or more of the activities, the procedures, and/or the processes in method 800 can be combined or skipped.

In activity 801, the account is considered active once the confirmation that creditors 180, 181, and 182 have received the notification has been received by communications management system 101.

In activity 802, borrowers 190, 191, and 192 can login into communications management system 101 using the credentials that they established in activity 601 of method 600 (FIG. 6).

In activity 803, borrowers 190, 191, and 192 are presented with a list of known defined accounts, labeled with the names previously provided by borrowers 190, 191, and 192. Borrowers 190, 191, and 192 can thus select one of those accounts.

In activity 804, once borrowers 190, 191, and 192 has selected a specific account, a list of all new events can be presented along with a list of all past events between borrowers 190, 191, and 192 and creditors 180, 181, and 182. The user can select a particular event.

In activity 805, a determination is made whether borrowers 190, 191, and 192 has reviewed this particular item before. If the item has been reviewed, the next activity is activity 807. If the item has been reviewed, the next activity is activity 806.

In activity 806, communications management system 101 is updated to note that the user has reviewed this previously unopened event. Such data can be used as a component of borrower's “response score.”

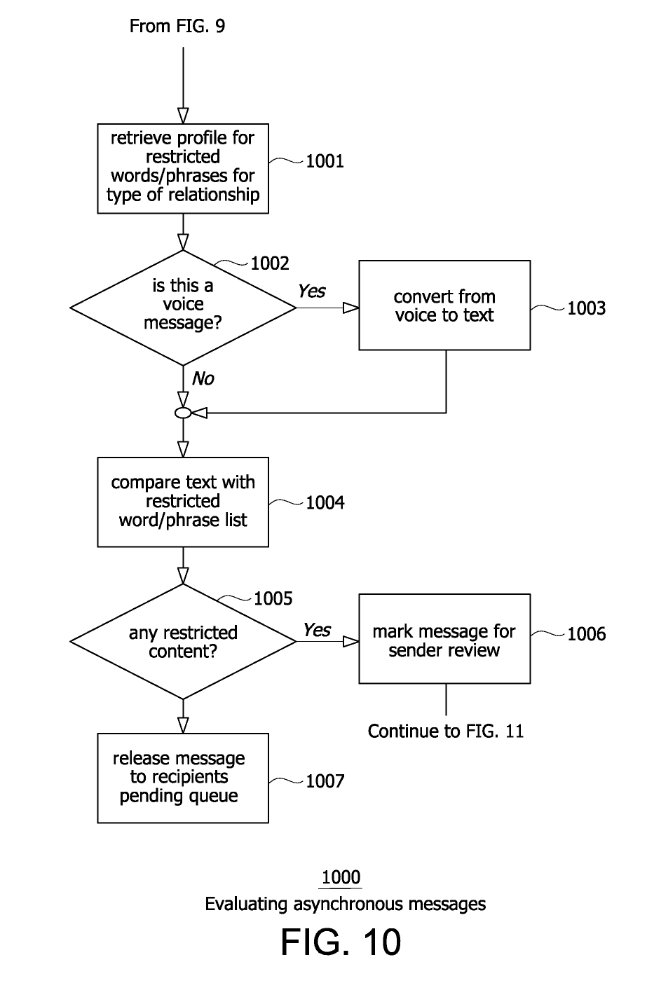

In activity 807, a borrower 190, 191, or 192 is asked whether it wants to respond to this particular event. If the user does not want to respond, the next activity is activity 804. If the user wants to respond, borrower 190, 191, and/or 192 is taken to activity 901 of method 900 (FIG. 9).

FIG. 9 illustrates a flowchart for method 900 for creating new communication. Method 900 is merely exemplary and is not limited to the embodiments presented herein. Method 900 can be employed in many different embodiments or examples not specifically depicted or described herein. In some embodiments, the activities, the procedures, and/or the processes of method 900 can be performed in the order presented. In other embodiments, the activities, the procedures, and/or the processes of method 900 can be performed in any other suitable order. In still other embodiments, one or more of the activities, the procedures, and/or the processes in method 900 can be combined or skipped.

In activity 901, borrowers 190, 191, and 192 can select from a list of allowable types of communication they want to initiate (e.g. phone call, voice mail, text, email, etc.).

In activity 902, a determination is made whether the selected type of communication is synchronous. If the type of communication is synchronous, the next activity is activity 908. If the type of communication is asynchronous, the next activity is activity 903.

Activities 903-907 relate to asynchronous messages as determined in activity 902. In activity 903, borrower 190, 191, or 192 creates the selected type of asynchronous message.

In activity 904, borrowers 190, 191, and 192 can review the created message.

In activity 905, borrower 190, 191, or 192 is asked whether the message should be sent to creditors 180, 181, and 182. If the message is to be sent, the next activity is activity 906. If the message is not to be sent, the next activity is activity 907.

In activity 906, the created message is queued by compliance module 111 for automated review.

In activity 907, the created message can be deleted. Communications management system 101 need not preserve any record of such deleted message if desired.

Activities 908-910 relate to synchronous messages as determined in activity 902. In activity 908, synchronous communication between both parties can be initiated, such as via synchronous communications module 141 such that the parties can interact in real time. An example of this type of communication is establishing a phone call between borrower 190, 191, or 192 and creditor 180, 181, or 182 and then recording the call.

In activity 909, if only one party remains in the synchronous communication, synchronous communications module 141 terminates the synchronous interaction.

In activity 910, data capture module 110 can store the communication event in the event log for that account. Note that communications management system 101 may send a notification about this new message based on the configuration of creditors 180, 181, and 182.

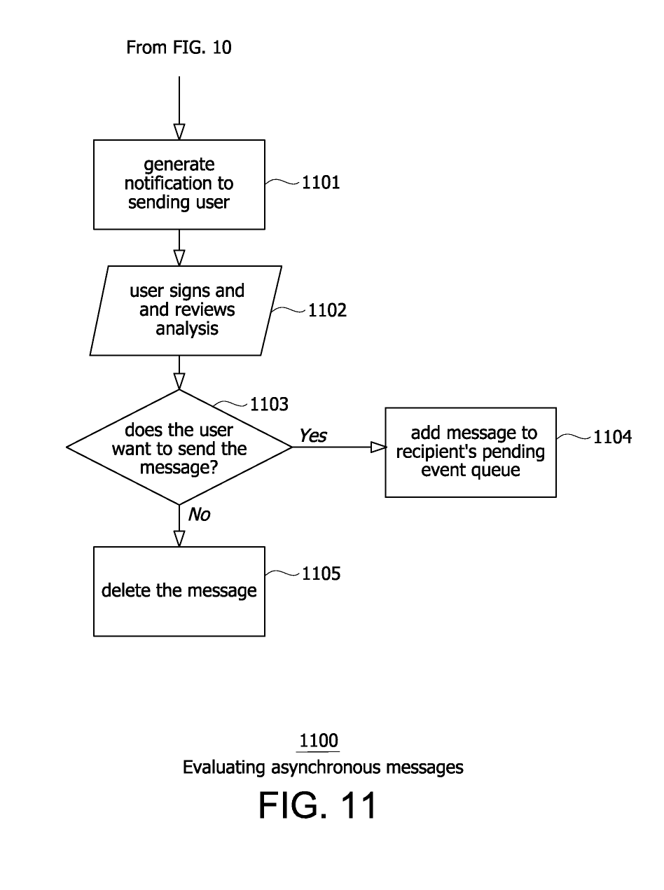

FIGS. 10 and 11 illustrate a flowchart for methods 1000 and 1100 for evaluating asynchronous messages. Methods 1000 and 1100 are merely exemplary and are not limited to the embodiments presented herein. Methods 1000 and 1100 can be employed in many different embodiments or examples not specifically depicted or described herein. In some embodiments, the activities, the procedures, and/or the processes of methods 1000 and 1100 can be performed in the order presented. In other embodiments, the activities, the procedures, and/or the processes of methods 1000 and 1100 can be performed in any other suitable order. In still other embodiments, one or more of the activities, the procedures, and/or the processes in methods 1000 and 1100 can be combined or skipped.

In activity 1001, an asynchronous message created by a party can be retrieved by communications management system 101 for evaluation. In some examples, activity 1001 is reached from activity 905 of method 900 (FIG. 9). In the same or other examples, the retrieved message can be one created by borrowers 190, 191, and 192 for creditors 180, 181, and 182, or by creditors 180, 181, and 182 for borrowers 190, 191, and 192. Before the retrieved message is released to the target recipient, it can be evaluated for compliance/surveillance purposes by compliance module 111. Compliance module 111 can retrieve a list of restricted words/phrases based on, for example, the type of account and/or borrower's or creditor's profile. Compliance module 111 can also retrieve a list of defined unacceptable vulgarities, which can be defined for all parties and/or accounts, for evaluating the retrieved message.

In activity 1002, asynchronous communications module 142 determines whether the retrieved message is a voice message. If so, asynchronous communications module 142 can convert it to text in activity 1003. Otherwise, method 1000 can proceed to activity 1004.

In activity 1003, asynchronous communications module 142 can generate a text file from the retrieved voice message, such as by using one or more open source or commercial voice-to-text applications. In some embodiments, the voice message can include two distinct files, each representing one side of the conversation. This can allow asynchronous communications module 142 to associate properly each word with the correct party.

In activity 1004, the text equivalent of the message can be scanned by compliance module 111 to detect any matches against the list of defined unacceptable vulgarities and/or the list of restricted words and phrases.

In activity 1005, if compliance module 111 detects a match for any unacceptable vulgarities or restricted words or phrases, method 1000 proceeds to activity 1006 where compliance module 111 can mark the message for review by the sender. In addition, at activity 1006, compliance module 111 could also update the response scoring for the sender party with data regarding the use unacceptable vulgarities or restricted words or phrases.

In activity 1007, if no restricted content was detected in activity 1005, asynchronous communications module 142 can release the message to the recipient's message review queue.

Method 1000 can continue in FIG. 11 with activity 1101 for generating a notification to the sender that compliance module 111 identified potentially inappropriate language in the sender's message.

In activity 1102, the user can sign into its account in communications management system 101 after receiving the notification of activity 1101. The sender can thus review the analysis of the sender's message by communications management system 101, and can also review the sender's message itself.

In activity 1103, if the sender determines to still send the message, method 1100 continues to activity 1104 where asynchronous communications module 142 delivers the message to the recipient's message review queue. In some examples, the message can no longer be deleted from the system. Otherwise, if the sender determines not to send the message, method 1100 continues to activity 1105, where the message is deleted. In some examples, the message is permanently removed from communications management system 101 once deleted.

In the same or different examples, creditors can sponsor account on communication management system 101 of one or more borrowers. That is, a creditor can hire the operator of communication management system 101 to offer communication management system 101 to its consumers (e.g., borrowers).

In this embodiment, the creditor gives a list of consumer accounts and some details about the consumers to the operator of communication management system 101. In various examples, communication management system 101 can generates a token for each consumer account and the tokens are given back to the creditor. The creditor then distributes those personalized codes to the consumers. If a consumer receives the personalized code and activates the code by going to communication management system 101. Communication management system 101 can create the appropriate account setup and notify the creditor that this consumer activated their account so the creditor can start contacting the consumer through communication management system 101. In this embodiment, the consumer can agree to a different terms of service where the consumer acknowledge that the creditor is paying for the service.

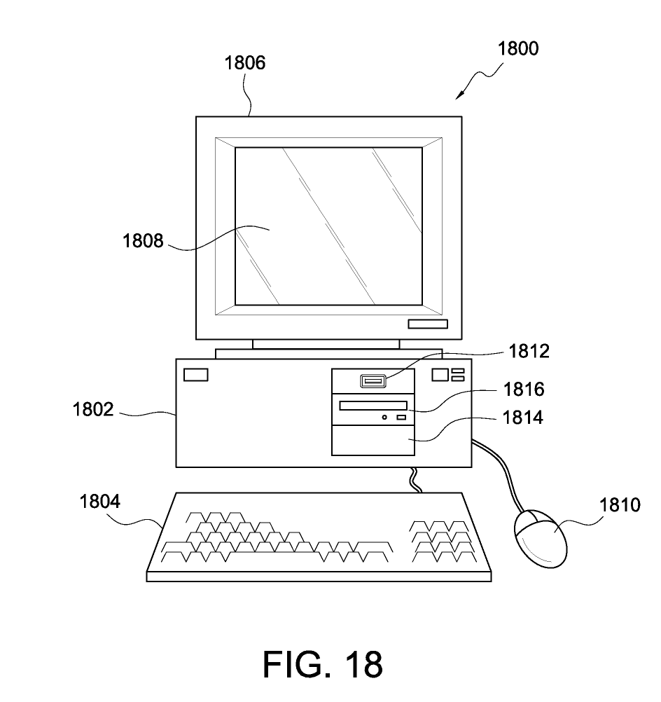

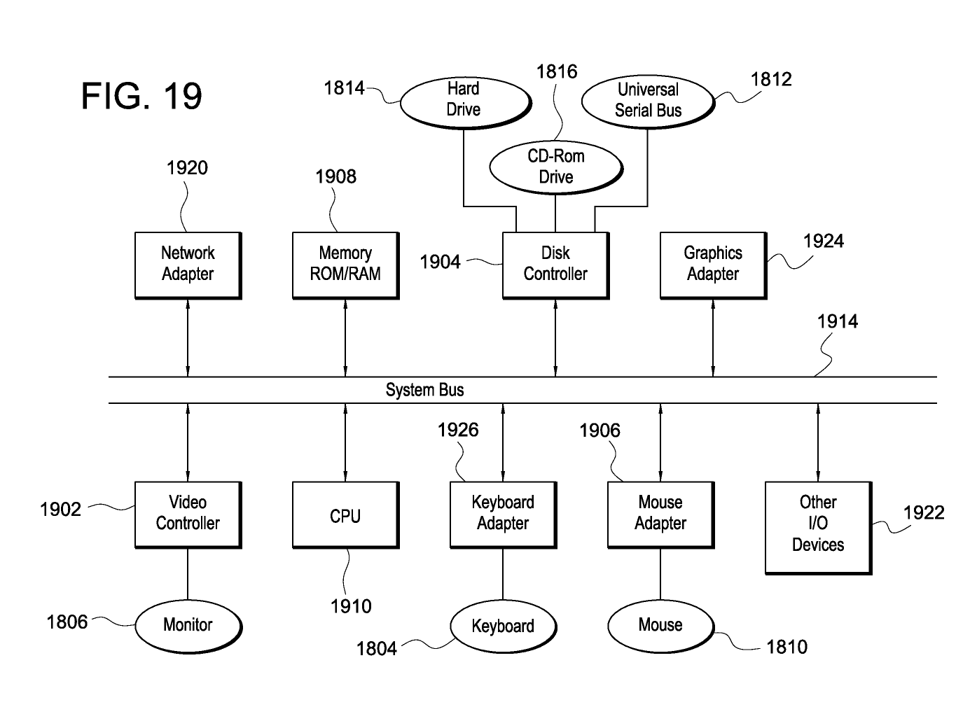

FIG. 18 illustrates a computer 1801 that is suitable for implementing an embodiment of at least a portion of communications management system 101 (FIG. 1) and/or creditors 180, 181, and 182, and/or borrower 190, 191, and 192. Computer 1801 includes a chassis 1802 containing one or more circuit boards (not shown), a USB (universal serial bus) port 1812, a Compact Disc Read-Only Memory (CD-ROM) and/or Digital Video Disc (DVD) drive 1816, and a hard drive 1814. A representative activity diagram of the elements included on the circuit boards inside chassis 1802 is shown in FIG. 19. A central processing unit (CPU) 1910 in FIG. 19 is coupled to a system bus 1914 in FIG. 19. In various embodiments, the architecture of CPU 1910 can be compliant with any of a variety of commercially distributed architecture families.

System bus 1914 also is coupled to memory 1908 that includes both read only memory (ROM) and random access memory (RAM). Non-volatile portions of memory 1908 or the ROM can be encoded with a boot code sequence suitable for restoring computer 1801 (FIG. 18) to a functional state after a system reset. In addition, memory 1908 can include microcode such as a Basic Input-Output System (BIOS). In some examples, storage component 115 (FIG. 1) can include non-volatile memory 1908, USB port 1812, hard drive 1814, and/or CD-ROM or DVD drive 1816.

In the depicted embodiment of FIG. 19, various I/O devices such as a disk controller 1904, a graphics adapter 1924, a video controller 1902, a keyboard adapter 1926, a mouse adapter 1906, a network adapter 1920, and other I/O devices 1922 can be coupled to system bus 1914. Keyboard adapter 1926 and mouse adapter 1906 are coupled to a keyboard 1804 (FIGS. 18 and 19) and a mouse 1810 (FIGS. 18 and 19), respectively, of computer 1801 (FIG. 18). While graphics adapter 1924 and video controller 1902 are indicated as distinct units in FIG. 19, video controller 1902 can be integrated into graphics adapter 1924, or vice versa in other embodiments. Video controller 1902 is suitable for refreshing a monitor 1806 (FIGS. 18 and 19) to display images on a screen 1808 (FIG. 18) of computer 1801 (FIG. 18). Disk controller 1904 can control hard drive 1814 (FIGS. 18 and 19), USB port 1812 (FIGS. 18 and 19), and CD-ROM or DVD drive 1816 (FIGS. 18 and 19). In other embodiments, distinct units can be used to control each of these devices separately.

Network adapters 1920 can be coupled to one or more antennas. In some embodiments, network adapter(s) 1920 are part of a WNIC (wireless network interface controller) card (not shown) plugged or coupled to an expansion port (not shown) in computer 1801. In other embodiments, the WNIC card can be a wireless network card built into internal computer 1801. A wireless network adapter can be built into internal client computer 1801 by having wireless Ethernet capabilities integrated into the motherboard chipset (not shown), or implemented via a dedicated wireless Ethernet chip (not shown), connected through the PCI (peripheral component interconnector) or a PCI express bus. In other embodiments, network adapter 1920 can be a wired network adapter.

Although many other components of computer 1801 (FIG. 18) are not shown, such components and their interconnection are well known to those of ordinary skill in the art. Accordingly, further details concerning the construction and composition of computer 1801 and the circuit boards inside chassis 1802 (FIG. 18) need not be discussed herein.

When computer 1801 in FIG. 18 is running, program instructions stored on stored on a USB drive in USB port 1812, on a CD-ROM or DVD in CD-ROM and/or DVD drive 1816, on hard drive 1814, or in memory 1908 (FIG. 19) are executed by CPU 1910 (FIG. 19). A portion of the program instructions, stored on these devices, can be suitable for carrying out methods 200, 500, 600, 700, 800, 900, 1000, and/or 1100 (FIGS. 2-11) as described previously with respect to FIGS. 2-17.

Returning to FIG. 1, although communications management system 101 has been described herein with respect to the exemplary implementation of computer 1800 in FIGS. 18-19, other devices or systems capable of receiving data via a network and processing such data in accordance with the present specification can be used to implement communications management system 101. In addition, any device that allows a user to communicate and receive data remote from communications management system 101 can be used as one of remote devices, even if such device is not described herein.

Although the invention has been described with reference to specific embodiments, it will be understood by those skilled in the art that various changes can be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that methods of claims 2-10 can be comprised of many different activities, procedures and be performed by many different modules, in many different orders that any element of FIG. 1 can be modified and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. An apparatus configured to provide communications and event tracking between a borrower and one or more creditors to the borrower, the apparatus comprising:
a defined contact module configured to run on at least one processor and further configured to allow the borrower to identify approved communications mechanisms, the approved communications mechanisms comprise allowed methods of communication from the one or more creditors to the borrower;
a legal notification generation module configured to run on the at least one processor and further configured to generated one or more appropriate legal notifications to the one or more creditors based upon the approved communications mechanisms;
a legal notification delivery module configured to run on the at least one processor and further configured to facilitate the delivery of the one or more appropriate legal notifications to the one or more creditors using a traceable mechanism; and
a communications module configured to run on the at least one processor and further configured to facilitate communication between the borrower and the one or more creditors using the approved communications mechanisms, the communications module comprises:
a synchronous communications module configured to provide real-time communications between the borrower and the one or more creditors; and
an asynchronous communications module configured to facilitate the borrower and the one or more creditors to provide asynchronous messages for each other in one or more formats.

2. The apparatus of claim 1, wherein:
the defined contact module is configured to communicate to the borrower through one or more graphical user interfaces and provide the user with options regarding one or more forms of communication with the one or more creditors; and
the approved communication mechanism comprises the options regarding the one or more forms of communication selected by the borrower.

3. The apparatus of claim 1, further comprising:
a data capture module configured to run on the at least one processor and further configured to capture the communications between the borrower and the one or more creditors.

4. The apparatus of claim 3, further comprising:
a non-volatile storage component configured to store the communications between the borrower and the one or more creditors captured by the data capture module.

5. The apparatus of claim 1, further comprising:
a compliance module configured to run on the at least one processor and further configured to ensure review of the asynchronous messages by the borrower and the one or more creditors.

6. The apparatus of claim 1, wherein:
the communications module is further configured to encrypt the communications between the borrower and the one or more creditors and configured to send notifications to the borrower when a message is received for the borrower from the one or more creditors.

7. The apparatus of claim 1, wherein:
the asynchronous communications module is further configured such that when one or more first messages of the asynchronous messages for the borrower or the one or more creditors are received by the asynchronous communications module, the asynchronous communications module notifies a receiving party of the borrower or the one or more creditors of the one or more first messages of the asynchronous messages.

8. The apparatus of claim 1, wherein:
the asynchronous communications module is further configured to allow the borrower and the one or more creditors to provide at least one of voice recording, text messages, email messages, or structured questions/responses for each other using the asynchronous communications module.

9. The apparatus of claim 1, wherein:
the legal notification generation module is configured to generate one or more modified cease and desist letters to the one more creditors based upon the approved communications mechanisms; and
one or more appropriate legal notifications comprise the one or more modified cease and desist letters.

10. The apparatus of claim 1, wherein:
the one or more appropriate legal notifications appoint at least one of an owner or an operator of the apparatus as the communication agent for the borrower; and
the one or more appropriate legal notifications waive one or more rights of the borrower when communications from the one or more creditors to the borrower occurs through the apparatus.

11. A method of managing communications between a borrower and one or more creditors, the method comprising:
using at least one computer processor to receive information regarding one or more approved communications mechanisms from the borrower, the one or more approved communications mechanisms comprise allowed methods of communication to the borrower from the one or more creditors;
using the at least one computer processor to generate one or more appropriate legal notifications to the one or more creditors based upon the approved communication mechanisms;
facilitating delivery of the one or more appropriate legal notifications to the one or more creditors using a traceable mechanism;
facilitating communications using one or more of the approved communications mechanisms between the one or more creditors and the borrower;
using the at least one computer processor to receive one or more asynchronous messages from at least one of the one or more creditors to the borrower to the other one via the one or more approved communications mechanisms; and
using the at least one computer processor to deliver the one or more asynchronous to the borrower.

12. The method of claim 11, further comprising:
providing a synchronous mechanism such that the borrower and the one or more creditors can have real-time communications.

13. The method of claim 11, further comprising:
facilitating real-time communications between the borrower and the one or more creditors, wherein:
the approved communications mechanisms comprise the real-time communications between the borrower and the one or more creditors.

14. The method of claim 11, further comprising:
using the at least one computer processor to ensure review of the asynchronous messages by the borrower and the one or more creditors.

15. The method of claim 11, further comprising:
using the at least one computer processor to determine if communications between the borrower and the one or more creditor is using the one or more approved communications mechanisms.

16. The method of claim 11, wherein:
using the at least one computer processor to generate the one or more appropriate legal notifications to the one or more creditors based upon the approved communication mechanisms;
using the at least one computer processor to generate generated one or more modified cease and desist letters to the one more creditors based upon the approved communications mechanisms; and
one or more appropriate legal notifications comprise the one or more modified cease and desist letters.

17. The method of claim 11, wherein:
using the at least one computer processor to receive the one or more asynchronous messages comprises:
using at least one computer processor to receive at least one of a voice recording, a text messages, an email message, or one or more structured questions from the one or more creditors to the borrower; and
the approved communications mechanisms comprise at least one of the voice recording, the text messages, the email message, or the one or more structured questions.

18. The method of claim 11, further comprising:
using the at least one computer processor to capture the communications between the borrower and the one or more creditors; and
storing the communications between the borrower and the one or more creditors in non-volatile memory.

19. The method of claim 11, wherein:
using the at least one computer processor to receive the information regarding one or more approved communications mechanisms comprises:
using the at least one computer processor to receive information from the borrower regarding the one or more creditors;
using the at least one computer processor to present the borrower with one or more options regarding communications between the borrower and the one or more creditors;
using the at least one computer processor to receive one or more selections of communications mechanisms from the borrower based upon the one or more options regarding communications between the borrower and the one or more creditors;
the one or more approved communications mechanisms comprise the one or more selections of communications mechanisms.

20. A communication management system configured to provide bi-directional, third-party hosted communications between two or more parties to one or more binding legal agreements, the communication management system is configured to run on one or more processors, the communication management system comprising:
a data gathering module configured to run on the at least one processor and further configured to receive data from a first party of the two or more parties via a computer network, the data comprises personal data about the first party, information regarding the binding legal agreement, and information regarding the one or more second parties to the binding legal agreement;
a decision module configured to run on the at least one processor and further configured to provide information to the first party regarding one or more approved communications mechanisms and further configured to receive a selection of one or more selected communications mechanisms from the first party, the one or more selected communications mechanisms comprise allowed methods of communication from the one or more second parties to the one or more binding legal agreements to the first party to the one or more binding legal agreements;
a legal notification generation module configured to run on the at least one processor and further configured to generated one or more appropriate legal notifications to the one or more second parties to the one or more binding legal agreements based upon the one or more approved communications mechanisms;
a legal notification delivery module configured to run on the at least one processor and further configured to facilitate delivery of the one or more appropriate legal notifications to the one or more second parties to the one or more binding legal agreements using a traceable mechanism;
a second party communications module is further configured to communicate with the one or more second parties to the one or more binding legal agreements via the computer network after the delivery of the one or more appropriate legal notifications to the one or more second parties;
a data capture module configured to run on the at least one processor and further configured to capture all interactions between the two or more parties that occurring using the communication management system, the data capture module is further configured to facilitate the two or more parties to view a history of all the interactions between the two or more parties captured by the data capture module;
a synchronous communications module configured to run on the at least one processor and further configured to initiate and capture synchronous communications between the one or more second parties;
an asynchronous communications module configured to run on the at least one processor and further configured to initiate and capture asynchronous communications directed to one of the two or more parties from another one of the two or more parties; and
a compliance module configured to run on the at least one processor and further configured to evaluate the responsiveness of each party of the two or more parties in a context of a specific legal agreement of the one or more binding legal agreements.
